(19) United States
(12) Patent Application Publication
(10) Pub. No.: US 2026/0217919 A1
(43) Pub. Date: Jul. 30, 2026

(54) MODIFIED TRIBLOCK COPOLYMER COMPOUNDS AND METHODS OF USE THEREOF

(71) Applicant: Roche Sequencing Solutions, Inc., Pleasanton, CA (US)

(72) Inventors: Peter Crisalli, Santa Clara, CA (US); Hannes Kuchelmeister, München (DE); Cezar Spiridon, Weilheim (DE); Jannik Wagner, Penzberg (DE)

(21) Appl. No.: 19/364,581

(22) Filed: Oct. 21, 2025

Related U.S. Application Data
(63) Continuation of application No. PCT/EP2024/062014, filed on May 24, 2024.
(60) Provisional application No. 63/464,053, filed on May 4, 2023.

(51) Int. Cl. C08G 81/00; C08G 85/00; C08K 3/08; C08K 3/28

(52) U.S. Cl. CPC C08G 81/00; C08G 85/002; C08G 85/004; C08K 3/08; C08K 3/28; C08K 2003/085; C08K 2201/011

(57) ABSTRACT

This application discloses triblock copolymers (TBC) molecules with modified chemical headgroup moieties. The headgroup moieties comprise azide, triazole, and other chemical moieties that make the TBC molecules useful as components in polymersome, vesicle, and membrane compositions, such as synthetic membranes used in nanopore sequencing devices. The application also discloses methods of preparing the modified TBC molecules and methods of use.

### CROSS REFERENCE TO RELATED APPLICATIONS

This patent application is a continuation of International Patent Application No. PCT/EP2024062014, filed May 2, 2024, which claims priority to and the benefit of U.S. Provisional Application No. 63/464,058, filed May 4, 2023. Each of the above patent applications is incorporated herein by reference as if set forth in its entirety.

### FIELD

This application relates to triblock copolymer compounds with modified chemical headgroup moieties that exhibit properties that make them useful as components in vesicle, polymersome, and membrane compositions, such as membranes used in nanopore sequencing devices.

### BACKGROUND

Nanopore-based nucleic acid sequencing is a compelling approach that has been widely studied. In one approach, the sequence a single-stranded polynucleotide is detected by changes in ionic current flow as the polynucleotide translocates through a nanopore embedded in a lipid bilayer membrane that separates two sides of an electrochemical cell. During the polynucleotide's translocation partial blockage of the nanopore aperture alters the ionic flow over time resulting in changes in current that can be measured by the cell.

Sequencing by Expansion (“SBX”) is a nanopore-based nucleic acid sequencing method that uses a biochemical process to transcribe the sequence of DNA onto a measurable polymer molecule referred to as an “Xpandomer.” See e.g., U.S. Pat. No. 7,939,259, entitled, “High Throughput Nucleic Acid Sequencing by Expansion;” and PCT publication WO2020236526A1, entitled “Translocation control elements, reporter codes, and further means for translocation control for use in nanopore sequencing.” In the SBX process, a target nucleic acid sequence is encoded along the backbone Xpandomer sequence with reporter constructs that are separated by ~10 nm that are designed to provide high-signal-to-noise, well-differentiated response signals during nanopore translocation. The enhanced signal-to-noise provided by the different response signals provides significantly increased sequence read efficiency and accuracy of Xpandomers relative to native nucleic acid molecules.

Nanopore-based sequencing-by-synthesis (“SBS”) uses a polymerase (or other strand-extending enzyme) covalently linked to a nanopore to synthesize a DNA strand complementary to a target sequence template (i.e., a copy strand). The nanopore embedded in a membrane in an electrochemical cell is used to concurrently detect the identity of each nucleotide monomer as it is added it to that growing strand. See e.g., US Pat. Publ. Nos. 2013/0244340 A1, 2013/0264207 A1, 2014/0134616 A1, 2015/0368710 A1, and 2018/0057870 A1, and published International Application WO 2019/166457 A1. Each added nucleotide monomer is detected by monitoring signals due to changes in ion flow through the nanopore as a tag moiety attached to each added nucleotide monomer enters the nanopore and alter the ion flow. For optimal performance, the tag moiety should reside in the nanopore for a sufficient amount of time to provide for a detectable, identifiable, and reproducible signal associated with altering ion flow through the nanopore (relative to the baseline “open current” flow), such that the specific nucleotide associated with the tag can be distinguished unambiguously from the other tagged nucleotides in the SBS solution.

Nanopore-based sequencing, however, are burdened by having to resolve small current signal differences immersed in significant background noise in a micro-volume electrochemical cell. This measurement challenge is complicated by small changes in the materials and parameters affecting the electrochemical cell including, but not limited to, the performance of the lipid bilayer with the embedded nanopore.

There is a need for triblock copolymer polymer compounds with improved properties for use in polymersome and membrane materials, such as in membranes in nanopore-based nucleic acid sequencing devices.

### SUMMARY

The present disclosure relates to triblock copolymer (TBC) compounds that have modified chemical headgroup moieties, and methods of making and using these compounds, and methods for using them in membrane and polymersome compositions. This summary is intended to introduce the subject matter of the present disclosure, but does not cover each and every embodiment, combination, or variation that is contemplated and described within the present disclosure. Further embodiments are contemplated and described by the disclosure of the detailed description, drawings, and claims.

In at least one embodiment, the present disclosure also provides novel triblock copolymer compounds of formula: R¹-(PMOXA)ₘ-(PDMS)ₙ-(PMOXA)ₘ-R²; wherein, R¹ is an azide or a terminal head group comprising a triazole; PMOXA is a poly(2-methyl-2-oxazoline) subunit; PDMS is a poly(dimethylsiloxane) subunit; R² is —OH, an azide, or a terminal head group comprising a triazole; and average values of n and m are: m is 4 to 20, and n is 20 to 60.

In at least one embodiment of the novel TBC composition, R¹ is a terminal head group comprising a triazole and R² is —OH, or R¹ and R² is a terminal head group comprising a triazole.

In at least one embodiment, the terminal head group comprising a triazole further comprises a group selected from: alcohol, azide, ester, amine, amide, alkyl, heteroalkyl, aryl, heteroaryl, carboxylate, terephthalate, phosphate, phosphatidylethanolamine, sulfonate, and sulfobetaine.

In at least one embodiment, the terminal head group comprising a triazole can further comprise a fluorescent moiety, such as a coumarin moiety or coumarin derivative moiety.

In at least one embodiment, the terminal head group comprising a triazole is selected from:

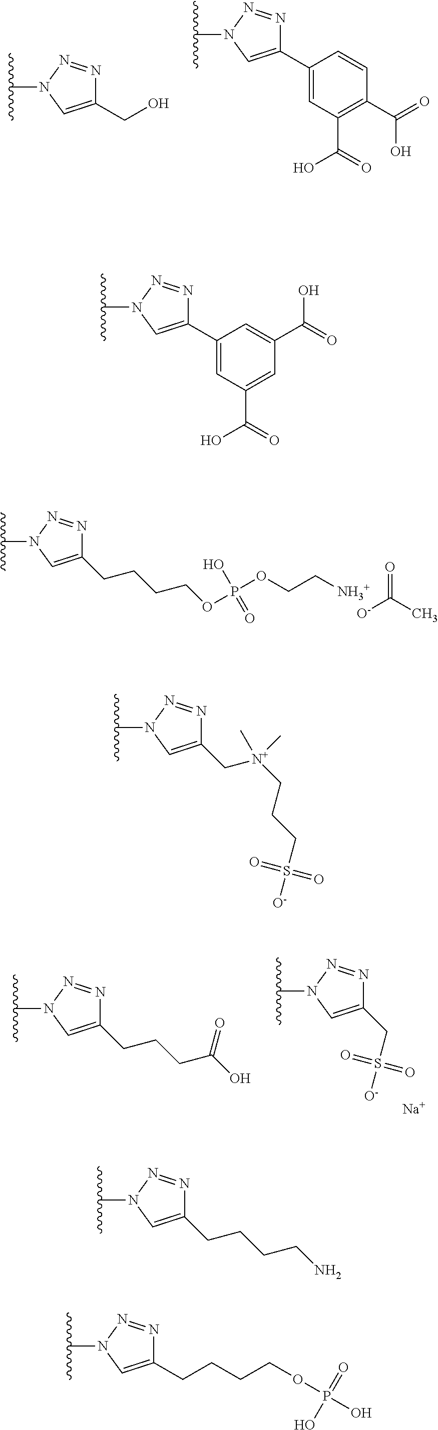

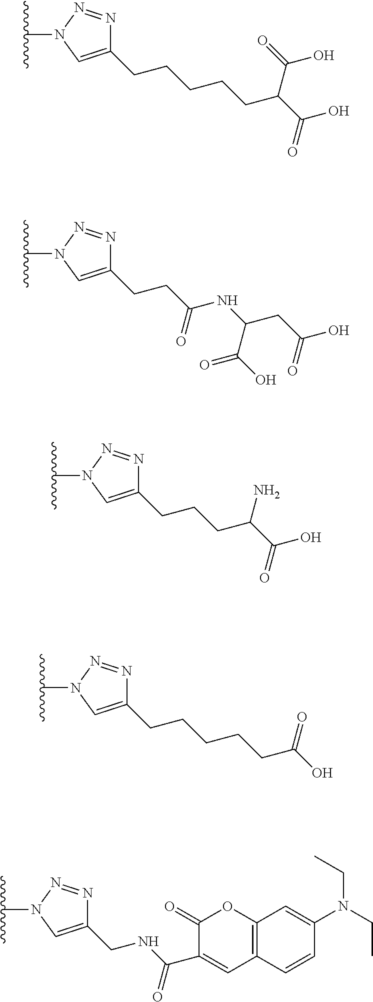 [SMILES: *n1cc(CCCCCC(C(=O)O)C(=O)O)nn1 ; *n1cc(CCC(=O)NC(CC(=O)O)C(=O)O)nn1 ; *n1cc(CCCC(N)C(=O)O)nn1 ; *n1cc(CCCCCC(=O)O)nn1 ; *n1cc(CNC(=O)c2cc3ccc(N(CC)CC)cc3oc2=O)nn1]

In at least one embodiment of the novel TBC composition, R¹ is an azide and R² is —OH, or R¹ and R² is an azide.

### BRIEF DESCRIPTION OF THE DRAWINGS

A better understanding of the novel features and advantages of the present disclosure will be obtained by reference to the following detailed description that sets forth illustrative embodiments, in which the principles of the disclosure are utilized, and the accompanying drawings (also “Figure” and “FIG.” herein), of which:

FIG. 1 depicts an embodiment of a cell 100 in a nanopore based sequencing chip.

FIG. 2 depicts an embodiment of a cell 200 performing nucleotide sequencing with the Nano-SBS technique.

FIG. 3 depicts an embodiment of a cell about to perform nucleotide sequencing with pre-loaded tags.

FIG. 4 depicts an embodiment of a process 400 for nucleic acid sequencing with pre-loaded tags.

FIG. 5 depicts an embodiment of a circuitry 500 in a cell of a nanopore based sequencing chip.

FIG. 6 depicts an embodiment of a circuitry 600 in a cell of a nanopore based sequencing chip, wherein the voltage applied across the nanopore can be configured to vary over a time period during which the nanopore is in a particular detectable state.

FIG. 7 depicts a schematic illustration of features of a generalized XNTP and its function in a Nano-SBX technique.

FIG. 8 depicts a schematic illustration of features of a generalized XNTP and its function in a Nano-SBX technique.

FIG. 9 depicts a schematic illustration of features of a generalized XNTP and its function in a Nano-SBX technique.

FIG. 10 depicts a schematic illustration of features of a generalized XNTP and its function in a Nano-SBX technique.

FIG. 11 is a schematic illustrating more details of one embodiment of an XNTP.

FIG. 12 is a schematic illustrating one embodiment of an Xpandomer passing through a biological nanopore.

FIG. 13A, FIG. 13B, FIG. 13C, and FIG. 13D depict heatmap images and plots illustrating the effect that differing amounts of TBC in DPhPE membranes has on the population of sequencing capable cells in a nanopore. FIG. 13A depicts results using a membrane of DPhPE only. FIG. 13B, FIG. 13C, and FIG. 13D depict results using a hybrid membrane of the following percentages of TBC Ch111 relative to DPhPE: 20% Ch111 (FIG. 13B); 30% Ch111 (FIG. 13C); or 40% Ch111 (FIG. 13D). A bimodal distribution in the vertical axis on the left inset of each image indicates the presence of a population of cells that are unable to perform the sequencing experiment. A single distribution indicates a single population of cells all capable performing the sequencing experiment.

FIG. 14A shows an exemplary ¹H-NMR spectrum in CD₂Cl₂ of the “living” polymer TBC compound α,ω-(hydroxy-, 2-methyl-2-oxazolinium triflate)-terminated poly(2-methyl-2-oxazoline)-block-polydimethylsiloxane-block-poly(2-methyl-2-oxazoline) of Scheme 1 after reaction solvents evaporation. The compound has the TBC formula PMOXA₈-PDMS₃₉-PMOXA₈, and 68 wt % PDMS, Mn=4.2 kDa, f_{(2-methyl-2-oxazolinium triflate)-}=70%, f_{hydroxy-}=30%, normalized to 4H (m, 0.55-0.45 ppm, —CH₂— vicinal to —Si(—CH₃)₂—O—).

FIG. 14B. shows an exemplary 1H-NMR spectrum in CDCl₃ of the “Ch111-type” TBC compound of Scheme 2 after dialysis and fractionation. The compound has the TBC formula PMOXA₁₂-PDMS₅₀-PMOXA₁₂, and 64 wt % PDMS, Mn_{CH111}=5.7 kDa, f_{acetyloxy-}=7%, f_{hydroxy-}=93%, normalized to 4H (m, 0.55-0.45 ppm, —CH₂— vicinal to —Si(—CH₃)₂—O—).

FIG. 14C depicts an exemplary 1H-NMR spectrum in CD₂Cl₂ of α,ω-(azide-, hydroxy-)-terminated poly(2-methyl-2-oxazoline)-block-polydimethylsiloxane-block-poly(2-methyl-2-oxazoline) of Scheme 3 after the described purification. The compound has the TBC formula PMOXA₁₁-PDMS₅₆-PMOXA₁₁, and 69 wt % PDMS, Mn=6 kDa, f_{azide-}ca. 90% and, f_{HO—} ca. 10%, normalized to 4H (m, 0.58-0.46 ppm, —CH₂— vicinal to —Si(—CH₃)₂—).

FIG. 14D depicts FT-IR spectra shown in overlay of the α,ω-(azide-, hydroxy-)-terminated poly(2-methyl-2-oxazoline)-block-polydimethylsiloxane-block-poly(2-methyl-2-oxazoline) TBC of Scheme 3 after solvent evaporation (grey), ultrafiltration (blue) and co-solvent fractionation (red).

FIG. 14E depicts an exemplary of 1H-NMR spectrum in CD₂Cl₂ of the “Ch127/128-type” TBC polymer α,ω-(hydroxy-,5-(1-polymer-1H-1,2,3-triazol-4-yl)isophthalic acid)-terminated poly(2-methyl-2-oxazoline)-block-polydimethylsiloxane-block-poly(2-methyl-2-oxazoline) of Scheme 4 after dialysis and fractionation. The compound has the TBC formula PMOXA₉-PDMS₃₀-PMOXA₉, and 58 wt % PDMS, Mn_{CH127}=3.8 kDa, f_{H5-(1-polymer-1H-1,2,3-triazol-4-yl)isophthalic acid}=76%, f_{hydroxy-}=24%, normalized to 4H (m, 0.59-0.46 ppm, —CH₂— vicinal to —Si(—CH₃)₂—O—).

### DETAILED DESCRIPTION

The present disclosure provides hybrid lipid bilayer compositions comprising a phospholipid, a triblock copolymer, and a molecule with a pore connecting the two sides of the bilayer, and the use of these lipid bilayer compositions in electrochemical cells. The electrochemical cells are useful for conducting nanopore-based methods of assaying nucleic acids, including nanopore-based sequencing. The features of the hybrid lipid bilayer compositions and the electrochemical cells that include them result in the surprising, advantageous result of reducing deleterious, error-inducing effects during the use of the cells in nanopore-based assays. The deleterious effects, sometimes referred to as proto-pore formation, may generate an unfavorable orientation for sequencing, can cause rapid clog the ports and/or the nanopore thereby greatly decreasing the accuracy and efficiency of any nanopore-based assay. The present disclosure also provides, methods for using the electrochemical cells and compositions for nanopore-based nucleic acid detection techniques, such as nanopore-based sequencing-by-synthesis (Nano-SBS) and nanopore-based sequencing by expansion.

For the descriptions herein and the appended claims, the singular forms “a,” and “an” include plural referents unless the context clearly indicates otherwise. Thus, for example, reference to “a protein” includes more than one protein, and reference to “a compound” refers to more than one compound. The use of “comprise,” “comprises,” “comprising” “include,” “includes,” and “including” are interchangeable and not intended to be limiting. It is to be further understood that where descriptions of various embodiments use the term “comprising,” those skilled in the art would understand that in some specific instances, an embodiment can be alternatively described using language “consisting essentially of” or “consisting of.”

Where a range of values is provided, unless the context clearly dictates otherwise, it is understood that each intervening integer of the value, and each tenth of each intervening integer of the value, unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding (i) either or (ii) both of those included limits are also included in the invention. For example, “1 to 50” includes “2 to 25”, “5 to 20”, “25 to 50”, “1 to 10”, etc.

Generally, the nomenclature used herein and the techniques and procedures described herein include those that are well understood and commonly employed by those of ordinary skill in the art, such as the common techniques and methodologies described in e.g., Green and Sambrook, Molecular Cloning: A Laboratory Manual (Fourth Edition), Vols. 1-3, Cold Spring Harbor Laboratory, Cold Spring Harbor, N.Y., 2012 (hereinafter “Sambrook”); and Current Protocols in Molecular Biology, F. M. Ausubel et al., eds., originally published in 1987 in book form by Greene Publishing Associates, Inc. and John Wiley & Sons, Inc., and regularly supplemented through 2011, and now available in journal format online as Current Protocols in Molecular Biology, Vols. 00-130, (1987-2020), published by Wiley & Sons, Inc. in the Wiley Online Library (hereinafter “Ausubel”).

All publications, patents, patent applications, and other documents referenced in this disclosure are hereby incorporated by reference in their entireties for all purposes to the same extent as if each individual publication, patent, patent application or other document were individually indicated to be incorporated by reference herein for all purposes.

Unless defined otherwise, all technical and scientific terms used herein have the same meaning as commonly understood by one of ordinary skill in the art to which the present disclosure pertains. It is to be understood that the terminology used herein is for describing particular embodiments only and is not intended to be limiting. For purposes of interpreting this disclosure, the following description of terms will apply and, where appropriate, a term used in the singular form will also include the plural form and vice versa.

Triblock Copolymers with Modified Headgroup Moieties

The present disclosure provides novel classes of (PMOXA)ₘ-(PDMS)ₙ-(PMOXA)ₘ triblock copolymer compounds with modified terminal head groups. This class of (PMOXA)ₘ-(PDMS)ₙ-(PMOXA)ₘ triblock copolymer compounds have one or two terminal head groups that comprise an azide group or a triazole group. As shown in the Examples, and elsewhere herein, these TBC compounds with novel terminal head group modifications can be used in vesicular systems, such as polymersome compositions, and in membrane compositions, including hybrid or fully synthetic membrane compositions. As shown in the Examples, these membrane compositions can provide improved properties to nanopore-based devices used in sequencing when incorporated in the membrane of the device.

It is a surprising advantage of the TBC compounds of the present disclosure that the chemical structure of the headgroups can be modified easily with various groups and further optimized to provide improved functional characteristics for the TBC when it is used in polymersome and membrane compositions. As described elsewhere herein, including the Examples below, a range of different headgroups have been prepared in the TBC compounds of formula R¹-(PMOXA)ₘ-(PDMS)ₙ-(PMOXA)ₘ-R² of the present disclosure.

Generally, the TBC compounds with modified headgroups are prepared using standard CuAAC click chemistry. As a result, the terminal head group R² and/or R¹ comprises a triazole moiety, and the CuAAC synthesis allows for a wide range TBC compounds with various different headgroups. For example, in at least one embodiment, the terminal head group R² and/or R¹ can comprise a fluorescent moiety, such as a coumarin moiety or coumarin derivative moiety. A wide range of fluorescent moieties are known in the art and can be incorporated as a HG into the TBCs of the present disclosure using standard CuAAC click chemistry as described in the Examples and elsewhere herein.

In at least one embodiment, the terminal head group R² and/or R¹ can comprise a group selected from: hydroxyl, alcohol, azide, ester, amine, amide, alkyl, heteroalkyl, aryl, heteroaryl, carboxylate, terephthalate, phosphate, phosphatidylethanolamine, sulfonate, and sulfobetaine.

Specific exemplary terminal headgroup structures useful in the TBCs of the present disclosure are provided in Table 1 below.

TABLE 1

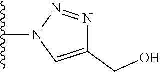 [SMILES: *n1cc(CO)nn1]

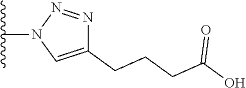 [SMILES: *n1cc(CCCC(=O)O)nn1]

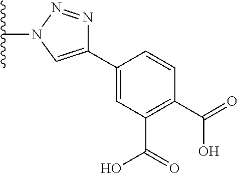 [SMILES: *n1cc(-c2ccc(C(=O)O)c(C(=O)O)c2)nn1]

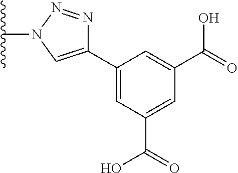 [SMILES: *n1cc(-c2cc(C(=O)O)cc(C(=O)O)c2)nn1]

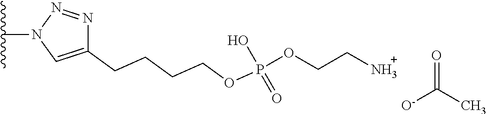

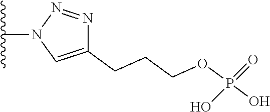 [SMILES: *n1cc(CCCOP(=O)(O)O)nn1]

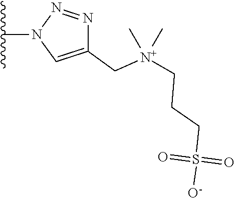 [SMILES: *n1cc(C[N+](C)(C)CCCS(=O)(=O)[O-])nn1]

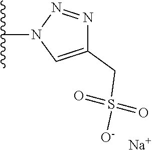 [SMILES: *n1cc(CS(=O)(=O)[O-])nn1 ; [Na+]]

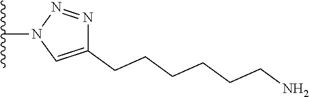 [SMILES: *n1cc(CCCCCCN)nn1]

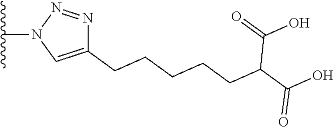 [SMILES: *n1cc(CCCCCC(C(=O)O)C(=O)O)nn1]

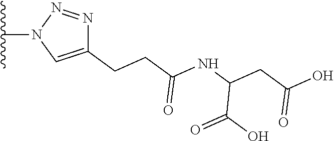 [SMILES: *n1cc(CCC(=O)NC(CC(=O)O)C(=O)O)nn1]

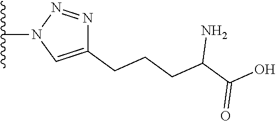 [SMILES: *n1cc(CCCC(N)C(=O)O)nn1]

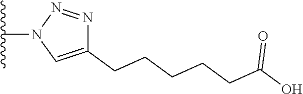 [SMILES: *n1cc(CCCCCC(=O)O)nn1]

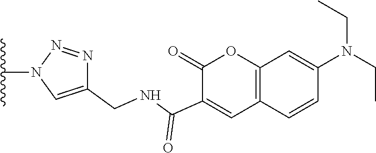 [SMILES: *n1cc(CNC(=O)c2cc3ccc(N(CC)CC)cc3oc2=O)nn1]

In at least one embodiment, the TBC compound can comprise different terminal headgroups R1 and R2, wherein only one of the headgroups (e.g., R1) comprises a triazole group. As such, it is contemplated that the other terminal headgroup can comprise other more standard headgroup moieties. Exemplary headgroup moieties can include, but are not limited to hydroxyl, alcohol, azide, ester, amine, amide, alkyl, heteroalkyl, aryl, heteroaryl, carboxylate, terephthalate, phosphate, phosphatidylethanolamine, sulfonate, and sulfobetaine. Specific headgroup moiety structures are shown in the Examples.

Preparation and use of TBCs comprising the specific exemplary head groups shown Table 1 are described in the Examples. It is further contemplated that further head groups based on chemical derivatives of these exemplary head group structures can be prepared, tested, and used in various TBC applications, such as hybrid membranes for nanopore sequencing Such chemical derivatives can be prepared from an alkyne version of the desired compound using standard CuAAC click chemistry as described in the Examples. The chemical derivatives may include any of the above specific structures further modified on an alkyl chain or aryl ring with a desired chemical group such as a halogen, a hydroxyl, an amine, or a charged group (e.g., sulfate, carboxylate).

As noted above, the TBC compounds with modified headgroups of the present disclosure are synthesized using standard CuAAC click chemistry as described in the Examples. Briefly, a TBC precursor of R¹-(PMOXA)ₘ-(PDMS)ₙ-(PMOXA)ₘ-R² with a terminal azide group at one or both R1 and/or R2 is prepared and then contacted with an alkyne derivative of the desired modified headgroup moiety, under suitable CuAAC click chemistry reaction conditions. Exemplary alkyne derivatives useful for preparing modified headgroups can include, but are not limited to, propargyl alcohol, hexynyl-PE, 3-(dimethyl(prop-2-yn-1-yl)ammonio), propane-1-sulfonate, 5-Hexynoic acid, sodium 2-propyne-1-sulfonate, oct-7-yn-1-amine, 5-ethynyl-1,3-benzenedicarboxylic acid, pent-4-yn-1-yl dihydrogen phosphate, 2-(hept-6-yn-1-yl)propanedioic acid, (2R)-2-(pent-4-ynamido)butanedioic acid, (S)-2-Aminohept-6-ynoic acid, and 7-(diethylamino)-2-oxo-N-(prop-2-yn-1-yl)-2H-chromene-3-carboxamide.

### Uses of Triblock Copolymers

Membranes as materials and components are essential to the function of a wide variety of processes and devices. In at least one embodiment, it is contemplated that the TBC compounds with modified headgroup moieties of the present disclosure can be used in hybrid membrane compositions. These compositions comprise lipid bilayers containing a mixture of a phospholipid and the TBC compound. It is a surprising property of the hybrid lipid bilayer compositions prepared using these TBC compounds that they provide enhanced accuracy and efficiency when used in certain nanopore-based electrochemical devices for detecting and/or sequencing nucleic acids. As described in the Examples, and elsewhere herein, a hybrid lipid bilayer composition comprising the TBC compounds with modified headgroups of the present disclosure, when incorporated in a nanopore-based device for nucleic acid sequencing can provide a 1.1-fold to 5-fold increase in the number of molecules sequenced per experiment relative to the same device using a standard non-hybrid lipid bilayer with no TBC.

The hybrid membrane compositions of the present disclosure that exhibit these enhanced characteristics are based on lipid bilayer comprising a mixture of a phospholipid and a triblock copolymer (or TBC). Typically, the amount of the triblock copolymer is about 2% to about 40% of mass of solids in the mixture with phospholipid that forms the bilayer. Methods for preparing hybrid membranes containing TBCs are known in the art and described in the Examples. Generally, the desired composition of phospholipid and TBC is prepared as a mixture in a solution of silicone oil and hexadecane.

The triblock copolymer used in the mixture can have a molecular weight of about 3500 Daltons to about 6500 Daltons. The triblock copolymer typically also has a polydispersity of about 1.1 to about 1.8. It is contemplated, however, that a wider range of polydispersity can be useful in various hybrid membrane applications.

As described in the Examples and elsewhere herein, a wide range of exemplary hybrid membranes of the present disclosure are based on a lipid bilayer composition using a poly(2-methyl-2-oxazoline)-block-poly(dimethylsiloxane)-block-poly(2-methyl-2-oxazoline) triblock copolymer, also referred to herein as a (PMOXA)ₘ-(PDMS)ₙ-(PMOXA)ₘ triblock copolymer. Although triblock copolymers of the structural formula (PMOXA)ₘ-(PDMS)ₙ-(PMOXA)ₘ are known in the art, compositions incorporating such TBCs in lipid bilayers with embedded nanopores, and the use of these hybrid membrane structures in nanopore-based sequencing methods are not.

TBCs useful in the lipid bilayer compositions of the present disclosure include the TBCs having the following formula: R¹-(PMOXA)ₘ-(PDMS)ₙ-(PMOXA)ₘ-R², where R¹ is a terminal headgroup comprising a triazole moiety and R² is a terminal headgroup comprising a triazole moiety or a hydroxyl group. In this formula “(PMOXA)” is the poly(2-methyl-2-oxazoline) subunit of the polymeric structure. Two (PMOXA) polymers each of m subunits flank and are covalently attached to a central poly(dimethylsiloxane) (or “PDMS”) polymer of n subunits. The terminal headgroups (or “HG”) at R¹, and optionally, R², are each a chemical group covalently linked to a terminal (PMOXA) subunit. In at least one embodiment, the TBC is symmetric, with both R¹ and R² being the same terminal HG. In at least one embodiment, the TBC is asymmetric, with R¹ and R² being different terminal HGs. In at least one embodiment, the TBC is asymmetric, and the R² group is a terminal hydroxyl group (or “—OH”) and the R¹ group a terminal HG.

The number of PMOXA and PDMS subunits in the polymeric structure of formula R¹-(PMOXA)ₘ-(PDMS)ₙ-(PMOXA)ₘ-R² are defined by the integer values “m” and “n.” In the exemplary TBCs of the present disclosure, m is 4 to 20, and n is 20 to 60. As shown in the tables describing the exemplary TBCs in the Examples, the structures of the TBCs can be indicated by two m and one n value. For example, “12-50-12” indicates a TBC of formula, R¹-(PMOXA)₁₂-(PDMS)₅₀-(PMOXA)₁₂-R². It is understood that the m and n values shown in the formulas for the exemplary TBCs of the present disclosure are averages of the range of m and n values that occur in the population of polymer molecules that occur during the synthesis of a TBC of the present disclosure. That is, a TBC indicated by “12-50-12” is actually a distribution of TBC molecules with the average values for m and n being 12 and 50, respectively. As disclosed elsewhere herein, including the Examples below, the specific m and n values that determine the ratio of PMOX and PDMS polymeric units in the TBC can be varied to provide TBCs with optimized functional characteristics when used in a hybrid membrane.

### Nanopore-Based Devices for Detecting Nucleic Acids

Nanopore-based devices for detecting nucleic acids have been developed for rapid sequencing and various designs and methods of use are known in the art. See e.g., U.S. Pat. Nos. 9,494,554B2, 9,567,630B2, 9,557,294B2, 9,605,309B2, each of which hereby incorporated by reference herein. These devices generally comprise an electrochemical cell with a chamber containing a nanopore embedded in a membrane. The membrane acts to separate the cell chamber into two sub-chambers, referred to as the cis and trans sides of the cell, each of which contain an electrode.

Generally, the membrane of such a device can be an organic membrane, such as a lipid bilayer, or a synthetic membrane made of a non-naturally occurring polymeric material. The present disclosure contemplates nanopore-based devices that include a hybrid membrane that comprises a bilayer mixture of a phospholipid and a triblock copolymer. As shown by the Examples herein, such hybrid membranes with TBCs can be embedded with a nanopore and used in a nanopore-based device to provide improved nucleic acid detection and sequencing. Thus, the following general disclosure of nanopore-based devices, their manufacture, and use, should be considered to include a hybrid membrane of the present disclosure.

The pore of the device is provided by the nanopore embedded in the membrane, which acts as a channel (or passage) between the cis and trans sides of the cell. Depending on the nanopore used, the pore has a width or diameter that can range from about 1 angstrom to about 10,000 angstroms. The nanopore can be a naturally-occurring pore-forming protein, such as α-hemolysin from S. aureus, non-naturally occurring mutant or variant of a wild-type pore-forming protein. A range of naturally and non-naturally occurring nanopores having varying pore-sizes and properties are known in the art. See e.g., U.S. Pat. Nos. 10,351,908B2, 10,934,582B2, 10,227,645B2.

Within the electrochemical cell, the nanopore embedded in the membrane is disposed in proximity to an electrode coupled to a sensing circuit, such as, for example, a complementary metal-oxide semiconductor (CMOS) or field effect transistor (FET) circuit. When a voltage potential is applied (via the electrodes) across a nanopore immersed in a conducting fluid, a small current attributed to the flow of ions through the nanopore can be observed. This ion flow is sensitive to the pore size, and thus, molecules entering the pore affect the ion flow and the voltage measured through this sensor circuit.

Electrochemical cells for nanopore-based sequencing of nucleic acids are typically used in a massively parallel fashion in which thousands of such cells are configured as an array in a single device often referred to as a chip (or bio-chip). A typically nanopore-based sequencing chip device incorporates an array of one million or more electrochemical cells, and may include 1000 rows by 1000 columns of such cells (see e.g., chips fabricated by Roche Sequencing Solutions, Santa Clara, CA, USA). Methods for fabricating and using such nanopore array microchips can also be found in U.S. Patent Application Publication Nos. 2013/0244340 A1, US 2013/0264207 A1, US2014/0134616 A1, 2015/0368710 A1, and 2018/0057870 A1, and published International Application WO 2019/166457 A1, each of which is hereby incorporated by reference herein. Each well in the array is manufactured using a standard CMOS process with surface modifications that allow for constant contact with biological reagents and conductive salts. Each well can support a phospholipid bilayer membrane with a nanopore-polymerase conjugate embedded therein. The electrode at each well is individually addressable by computer interface. All reagents used are introduced into a simple flow cell above the array microchip using a computer-controlled syringe pump. The chip supports analog to digital conversion and reports electrical measurements from all electrodes independently at a rate of over 1000 points per second. Nanopore measurements can be made asynchronously at each of 8 M addressable nanopore-containing membranes in the array at least once every millisecond (msec) and recorded on the interfaced computer. Further description of exemplary electrochemical cells useful for nanopore-based nucleic acid assays, such as sequencing, including chamber and electrode materials, buffer solutions, sensing circuitry, array devices, and their use in various applications is provided below.

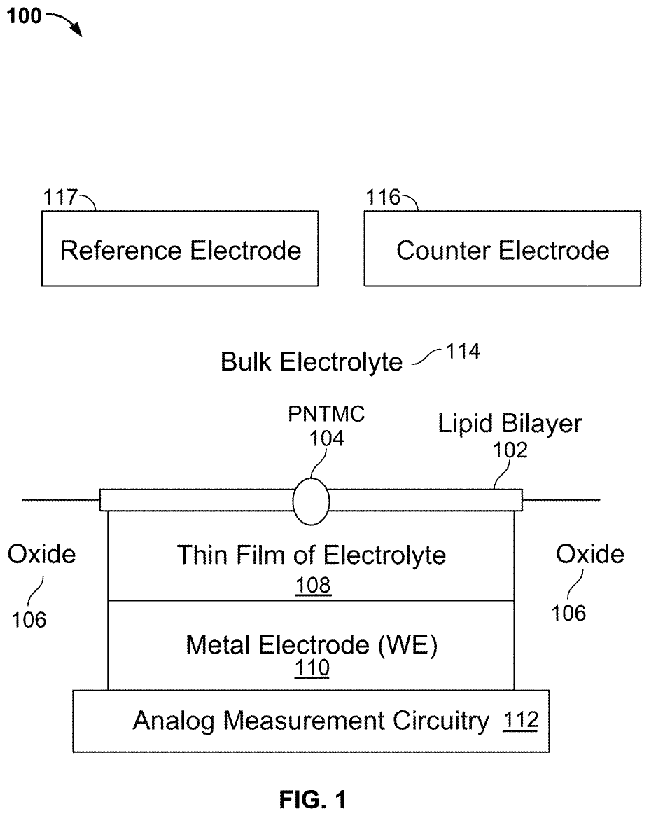

FIG. 1 illustrates an exemplary embodiment of an electrochemical cell 100 found in an array of such cells useful for nanopore-based sequencing. A membrane 102 is formed over a surface in the cell. In some embodiments, the membrane 102 is a lipid bilayer. A bulk electrolyte solution 114 containing the nanopore or “protein nanopore transmembrane molecular complex” (PNTMC) 104 is placed directly onto this surface in the cell and electroporation is used to insert a single PNTMC 104 into the membrane 102. The individual nanopore embedded membranes in each cell of an array are neither chemically nor electrically connected to each other. Thus, each cell is an independent sequencing machine, producing data unique to the single polymer molecule associated with the PNTMC.

With continued reference to FIG. 1, a thin film of electrolyte solution 108 is isolated from the bulk electrolyte solution 114 by the ion-impermeable membrane 102. The nanopore embedded membrane thus separates the electrochemical cell 100 into two chambers, a cis chamber containing the bulk electrolyte solution 114, and a trans chamber containing the thin film of electrolyte solution 108. The thin film of electrolyte solution 108 in the trans chamber is in contact with a metal working electrode 110 that is connected to analog measurement circuitry 112. The bulk electrolyte solution in the cis chamber is in contact with a counter electrode 116 and a reference electrode 117.

The pore of the PNTMC 104 provides a channel through the membrane 102 that allows analytes (e.g., nucleic acids) and ions to flow, which results in modulation of the ionic current across the impermeable bilayer. The pore of the PNTMC 104 thus provides the only path for ion current to flow from the metal working electrode 110 to the bulk electrolyte solution 114 in contact with the counter electrode 116. The electrochemical cell also includes a reference electrode 117, which further enhances it sensitivity as an electrochemical potential sensor.

The thin film of electrolyte constitutes a femtoliter volume of solution in the trans chamber that is in direct contact with the working electrode. This small volume of electrolyte contacting the electrodes of the electrochemical cell must undergo repeated voltage pulses in sensing ion flow through the nanopore. These repeated electrochemical measurements using electrodes in a small volume of electrolyte and the need to maintain ion flow through a nanopore with repeated measurements corresponding to individual molecular moieties translocating through the pore requires a sensor system of exquisite sensitivity. This electrochemical measurement system is highly sensitive to any precipitating or aggregating molecular entities that can clog the pore or otherwise interfere with the ionic flow between the working and counter electrode. Accordingly, the electrolyte salts, electrochemical cell materials, and electrochemical measurement conditions should be carefully controlled to prevent or reduce deleterious precipitant formation or electrode wear in the system.

The electrolyte solution 108 may include one of the following: lithium chloride (LiCl), sodium chloride (NaCl), potassium chloride (KCl), lithium glutamate, sodium glutamate, potassium glutamate, lithium acetate, sodium acetate, potassium acetate, ammonium chloride, ammonium acetate, calcium chloride (CaCl₂)), strontium chloride (SrCl₂), manganese chloride (MnCl₂), and magnesium chloride (MgCl₂). In some embodiments, the film of electrolyte solution has a thickness of about three microns (μm). The thickness of the film of electrolyte solution may range from 0-5 microns.

In addition to the salts described above, the electrolyte film can contain redox active ions such as ferrocyanide ion and ferricyanide ion. These redox ions are used in certain nanopore-based sequencing methods carried out in the electrochemical cell. For example, Nano-SBX measurements carried out in a cell of the present disclosure can comprise ferricyanide and ferrocyanide ions. Such redox active ions can undergo irreversible reactions depending on their concentration and the particular electrochemical conditions at the working and counter electrodes. Indeed, as described elsewhere herein, the irreversible formation of the precipitant Prussian Blue in an electrochemical cell is highly deleterious to any nanopore-based measurements in the cell. Accordingly, the concentration of such redox active ions as ferricyanide and ferrocyanide should carefully controlled. In at least one embodiment of the present disclosure, any ferricyanide and ferrocyanide ions in the solutions in the electrochemical cell should be maintained at a total concentration of between about 25 mM and 250 mM.

It has also been found that the salts used in electrolyte solutions of the electrochemical cell can affect the ability of the cell to be used in sensitive nanopore-based nucleic acid measurements. For example, many nanopore-based sequencing protocols use ammonium chloride as a buffer salt in the electrolyte solutions provided in the cell chambers. It has been found that controlling the concentration of ammonium chloride by substituting with ammonium acetate as a salt in the electrolyte solution during nanopore-based nucleic acid sequencing methods, such as Nano-SBX, can help reduce or prevent the formation of redox precipitants, such as Prussian Blue, which is, as mentioned above, highly deleterious to the accuracy and sensitivity of the electrochemical cell. Accordingly, in some embodiments of the electrochemical cell of the present disclosure, the buffer composition used in the cell comprises ammonium acetate at a concentration of from about 0 mM to about 1500 mM, and/or ammonium chloride at a concentration of less than 2000 mM. In at least one embodiment, the buffer composition comprises ammonium acetate at a concentration of from about 0 mM and 1500 mM and an ammonium chloride at a concentration of less than 2000 mM. In at least one embodiment, the concentration of ammonium acetate is 0 mM and the concentration of ammonium chloride is about 600 mM.

Dielectric materials are typically used to form oxide layers 106 that define the trans chamber of the cell. Useful dielectric materials can include glass, oxide, silicon mononitride (SiN), and the like. In some embodiments, the top surface of dielectric oxide layer 106 in that is in contact with bulk electrolyte 114 may be silanized. Silanization forms a hydrophobic layer above the top surface of dielectric layer. In some embodiments, this hydrophobic layer has a thickness of about 1.5 nanometer (nm). Alternatively, dielectric material that is hydrophobic such as hafnium oxide may be used to form the top of the dielectric layer.

As shown in FIG. 1, the membrane is a lipid bilayer formed at least partially on the dielectric oxide layer 106 and spans across the well containing the thin film of electrolyte 108. For example, the membrane can form on top of the hydrophobic layer on the dielectric oxide layer and as the membrane reaches the opening of well, the lipid monolayer transitions to a lipid bilayer that spans across the opening of the well. The hydrophobic layer can facilitate the formation of lipid monolayer above dielectric layer and the transition from a lipid monolayer to a lipid bilayer.

The bulk electrolyte 114 may further include one of the following: lithium chloride (LiCl), sodium chloride (NaCl), potassium chloride (KCl), lithium glutamate, sodium glutamate, potassium glutamate, lithium acetate, sodium acetate, potassium acetate, calcium chloride (CaCl₂)), strontium chloride (SrCl₂), manganese chloride (MnCl₂), and magnesium chloride (MgCl₂). Accordingly, in some embodiments of the electrochemical cell of the present disclosure, the buffer composition of the bulk electrolyte used in the cell comprises ammonium acetate at a concentration of from about 0 mM to about 1500 mM, and/or ammonium chloride at a concentration of less than 2000 mM. In at least one embodiment, the buffer composition comprises ammonium acetate at a concentration of from about 0 mM and 1500 mM and an ammonium chloride at a concentration of less than 2000 mM. In at least one embodiment, the concentration of ammonium acetate is 0 mM and the concentration of ammonium chloride is about 600 mM. Similarly, in some embodiments, any ferricyanide and ferrocyanide ions in the bulk electrolyte solution of the electrochemical cell should be maintained at a total concentration of between about 25 mM and 250 mM.

As noted above with respect to the thin electrolyte film, the composition of the salts (e.g., ammonium chloride versus ammonium acetate) and redox active ions used in the bulk electrolyte can affect the accuracy and sensitivity of the nanopore-based measurements made using the electrochemical cell. It is contemplated that depending on the type of electrochemical measurement being carried out, particularly the applied potentials across the electrodes in contact the solution, the composition of the solution can be adjusted to reduce or prevent deleterious precipitant formation.

In order to carry out the necessary insertion and removal of solutions, the electrochemical cells of the present disclosure include inlet and outlet ports operably connected to the chambers or reservoirs of the cell. The electrochemical cell schematic of FIG. 1 does not depict the inlet and outlet ports but the incorporation of such ports into electrochemical cells are well known in the art. The inlet and outlet ports allow the insertion of the reagents required for nanopore-based nucleic acid detection including the materials for creating the membrane with embedded nanopore, the nucleotide synthesis reagents, and the electrolyte and buffer solutions. Typically, the inlet and outlet ports comprise metal (e.g., stainless steel) tubes fitted to the cell so as to provide a fluid connection from the outside into the chambers of the cell that can be used to insert or remove solutions. As such, at least a portion of the inlet and outlet port tubing is in contact with the electrochemical solutions in the cell chambers. Optimally, the composition of the ports should be electrochemically inert at the voltages used to induce ion flow through the nanopore and make the sensory measurements of changes in ion flow as molecular moieties enter and/or translocate through the nanopore.

The electrochemical cell 100 includes a counter electrode (CE) 116 and a reference electrode 117, which acts as an electrochemical potential sensor. In some embodiments, counter electrode 116 is shared between a plurality of cells and is therefore also referred to as a common electrode. The common electrode can be configured to apply a common potential to the bulk liquid in contact with the nanopores in the plurality of cells. The common potential and the common electrode are common to all of the measurement cells.

In at least one embodiment, it has been found that a non-faradaic electrochemical cell with a titanium nitride (TiN) working electrode can be advantageous for nanopore-based sequencing of nucleic acids. The cell is similar in general structure to the cell of FIG. 1 but includes a TiN working electrode that exhibits increased electrochemical capacitance. The electrochemical cell further includes a conductive or metal layer that connects the working electrode of the cell to the circuitry of the array of which the cell is part

Accordingly, in at least one embodiment, the metal working electrode 110 is a titanium nitride (TiN) metal electrode with increased electrochemical capacitance. The electrochemical capacitance associated with metal working electrode 110 may be increased by maximizing the specific surface area of the electrode. The specific surface area of the metal working electrode 110 is the total surface area of the electrode per unit of mass (e.g., m²/kg) or per unit of volume (e.g., m²/m³ or m⁻¹) or per unit of base area (e.g., m²/m²). As the surface area increases, the electrochemical capacitance of the metal working electrode increases, and a greater number of ions can be displaced with the same applied potential before the capacitor becomes charged. The surface area of working electrode 110 may be increased by making the TIN electrode “spongy” or porous. The TiN sponge soaks up electrolyte and creates a large effective surface area in contact with the electrolyte.

The ratio of the capacitance associated with the membrane (C_{membrane}) and the capacitance associated with the working electrode (C_{electrochemical}) may be adjusted to achieve optimal overall system performance. Increased system performance may be achieved by reducing C_{membrane} while maximizing C_{electrochemical}. C_{membrane} is adjusted to create the required RC time constant without the need for additional on-chip capacitance, thereby allowing a significant reduction in cell size and chip size. The base surface area of the metal working electrode 110 is greater than or equal to the surface area of the opening of the trans side well containing the electrolyte 108 with walls defined by the oxide layers 106. Therefore, the two base surface areas may be optimized independently to provide the desired ratio between C_{membrane} and C_{electrochemical}. By using a spongy and porous TiN working electrode, the electrolyte can diffuse through the spaces between the columnar TiN structures and vertically down the uncovered portion of the working electrode and then horizontally to the covered portion of working electrode 1102 that is underneath dielectric layer 1104. As a result, the effective surface area of TiN that is in contact with the electrolyte is maximized and C_{electrochemical} is maximized.

Further description of the design of non-faradaic electrochemical cells, TiN working electrodes, and other nanopore-based cell designs useful with the devices, compositions, and methods of the present disclosure can be found in e.g., U.S. Pat. No. 10,174,371B2, which is hereby incorporated by reference herein.

As described elsewhere herein, the electrochemical cells of the present disclosure can be used as devices for nanopore-based nucleic acid detection and measurement assays, including nucleic acid sequencing. Generally, nanopore-based sequencing of a target nucleic acid can be carried using an electrochemical cell of design described above, and the associated solution compositions, including electrolyte and buffer solutions that reduce precipitant formation as described above. The method comprises: (a) providing an electrochemical cell comprising (i) a nanopore embedded in a membrane that separates the cell into cis and trans chambers operably connected by the nanopore, wherein the cis and trans chambers each contain an electrode, a solution comprising ferrocyanide ion, ferricyanide ion, and a buffer composition; and (ii) inlet and outlet ports comprising a metal operably connected to the cell; (b) adding a molecule derived from a target nucleic acid to the cis chamber; (c) applying a voltage to the cell that causes at least a portion of the molecule to translocate through the nanopore; and (d) detecting changes in voltage flow in the cell as the molecule translocates through the nanopore, wherein the changes in voltage flow are indicative of a sequence of the target nucleic acid.

As described elsewhere herein, the particular potentials applied, their timing and duration can have a significant effect on the highly sensitive changes in ion flow conductance through the nanopore that occurs in the presence of the nucleic acid molecular moieties being detected in carrying out a sequencing method. Exemplary methods and parameters for application of voltage potentials across nanopore-based electrochemical cell arrays for sequencing are known in the art and described in e.g., U.S. Pat. Nos. 11,150,216 and 11,029,306, each of which is hereby incorporated by reference herein. The applied potentials, their pulse timing and duration can also affect the redox chemistry inside the cell resulting in the formation of deleterious precipitants such as Prussian Blue. It is a surprising advantage of the electrochemical cells and associated solutions used in them of the present disclosure that in some embodiments, a method of nanopore sequencing using an electrochemical cell of the present disclosure can be carried out using an alternating current (AC) applied to the cell with a voltage range of 450 mV to 1200 mV for 10 hours resulting in no visible formation of Prussian Blue in the cell.

In some embodiments of the method for sequencing of the present disclosure, the applied voltage comprises applying a baseline voltage potential to the cell. A typical baseline voltage applied can be in the range of from about 55 mV to about 95 mV.

In some embodiments of the methods for sequencing, the applied voltage can include a pulse voltage. Pulse voltages useful in the method can be from about 320 mV to about 550 mV. The duration of the pulse voltage typically is from about 5 μs to about 15 μs. In at least one embodiment, the time between pulse voltages is about 0.2 ms to 5 ms. In at least one embodiment, the applied voltage provides an alternating current to the electrochemical cell. For example, the resulting alternating current can have a periodicity of about 0.4 s to about 6 s.

In at least one embodiment, it is contemplated that an array of electrochemical cells of the present disclosure can be used to carry out a method of sequencing in a parallel fashion. Such parallel nanopore-based sequencing of nucleic acids using parallel arrays of electrochemical cells have been used with the nanopore-based sequencing by synthesis (Nano-SBS) technique. Systems compositions, and methods for Nano-SBS are known in the art. See e.g., US Pat. Publ. Nos. 2013/0244340 A1, 2013/0264207 A1, 2014/0134616 A1, 2015/0368710 A1, and 2018/0057870 A1, and published International Application WO 2019/166457 A1. It is contemplated that these known systems, compositions and methods can be used or adapted for use with the electrochemical cells of the present disclosure. A description of the use Nano-SBS in the context of the electrochemical cells and compositions of the present disclosure is provided below.

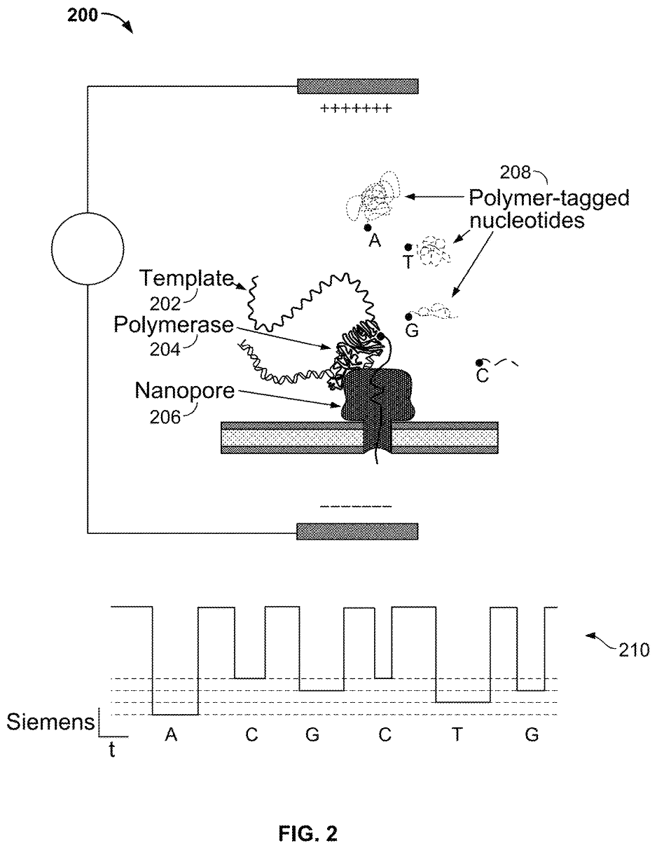

FIG. 2 illustrates an embodiment of an electrochemical cell 200 used to carry out nanopore-based nucleic acid sequencing with the Nano-SBS technique. In the Nano-SBS technique, a template 202 to be sequenced and a primer are introduced into an electrochemical cell 200. To this template-primer complex, four differently tagged nucleotides 208 are added to the bulk aqueous phase. As the correctly tagged nucleotide is complexed with the polymerase 204, the tail of the tag is positioned in the barrel of nanopore 206. The tag held in the barrel of nanopore 206 generates a unique ionic blockade signal 210, thereby electronically identifying the added base due to the tags' distinct chemical structures.

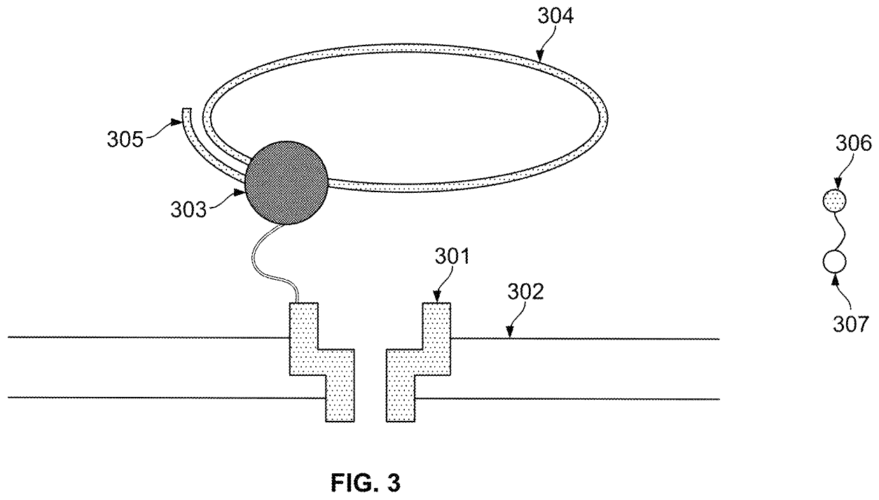

FIG. 3 illustrates an embodiment of a cell about to perform nucleotide sequencing with pre-loaded tags. A nanopore 301 is formed in a membrane 302. An enzyme 303 (e.g., a polymerase, such as a DNA polymerase) is associated with the nanopore. In some cases, the enzyme 303 is covalently attached to nanopore 301. Polymerase 303 is associated with a nucleic acid molecule 304 to be sequenced. The associated nucleic acid molecule 304 can be linear or circular. In some embodiments, a nucleic acid primer 305 is hybridized to a portion of nucleic acid molecule 304. The polymerase 303 catalyzes the incorporation of nucleotides 306 onto primer 305 using single stranded nucleic acid molecule 304 as a template. As noted above, the nucleotides 306 comprise a tag species (“tags”) 307 that allows it to be distinguished from the other three nucleotides.

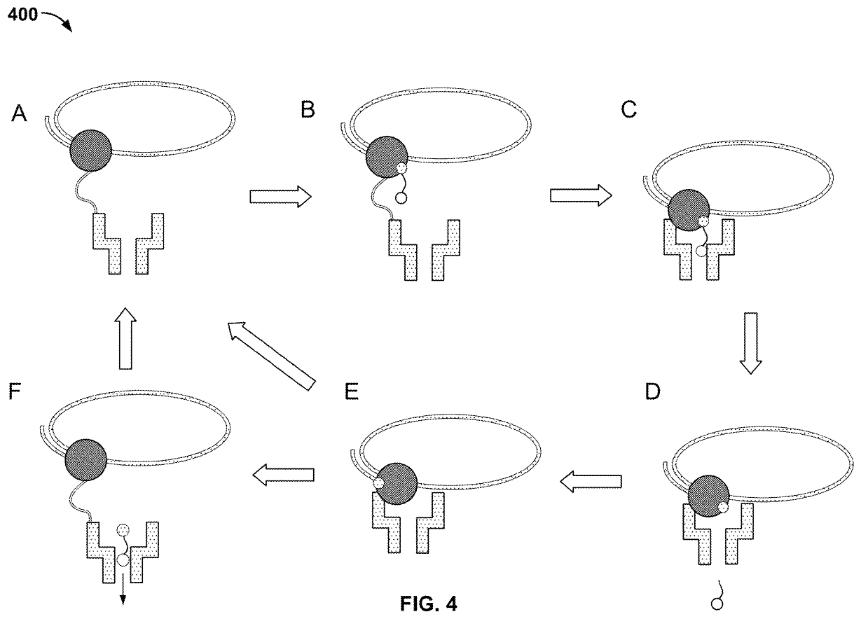

FIG. 4 illustrates an embodiment of a process 400 for nucleic acid sequencing with pre-loaded tags. At stage A, a tagged nucleotide (one of four different types: A, T, G, or C) is not associated with the polymerase. At stage B, a tagged nucleotide is associated with the polymerase. At stage C, the polymerase is in close proximity to the nanopore. The tag is pulled into the nanopore by an electrical field generated by a voltage applied across the membrane and/or the nanopore. Some of the associated tagged nucleotides are not base paired with the nucleic acid molecule. These non-paired nucleotides typically are rejected by the polymerase within a time scale that is shorter than the time scale for which correctly paired nucleotides remain associated with the polymerase. Since the non-paired nucleotides are only transiently associated with the polymerase, process 400 as shown in FIG. 4 typically does not proceed beyond stage B.

Before the polymerase is docked to the nanopore, the conductance of the nanopore is ~300 pico Siemens (300 pS). At stage C, the conductance of the nanopore is about 60 pS, 80 pS, 100 pS, or 120 pS corresponding to one of the four types of tagged nucleotides. The polymerase undergoes an isomerization and a transphosphorylation reaction to incorporate the nucleotide into the growing nucleic acid molecule and release the tag molecule. In particular, as the tag is held in the nanopore, a unique conductance signal (e.g., see signal 210 in FIG. 2) is generated due to the tag's distinct chemical structures, thereby identifying the added base electronically. Repeating the cycle (i.e., stage A through E or stage A through F) allows for the sequencing of the nucleic acid molecule. At stage D, the released tag passes through the nanopore.

In some cases, tagged nucleotides that are not incorporated into the growing nucleic acid molecule will also pass through the nanopore, as seen in stage F of FIG. 4. The unincorporated nucleotide can be detected by the nanopore in some instances, but the method provides a means for distinguishing between an incorporated nucleotide and an unincorporated nucleotide based at least in part on the time for which the nucleotide is detected in the nanopore. Tags bound to unincorporated nucleotides pass through the nanopore quickly and are detected for a short period of time (e.g., less than 10 ms), while tags bound to incorporated nucleotides are loaded into the nanopore and detected for a long period of time (e.g., at least 10 ms).

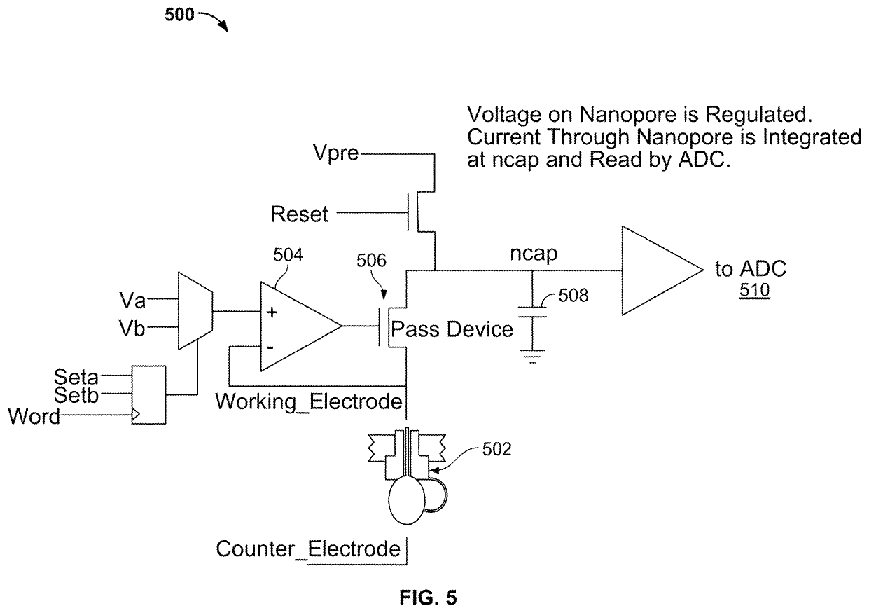

FIG. 5 illustrates an embodiment of a circuitry 500 in an electrochemical cell of a nanopore-based sequencing chip. As mentioned above, when a molecular moiety (e.g., a tag) enters nanopore 502, a unique conductance signal (e.g., see signal 210 in FIG. 2) is generated due to the distinct chemical structure and how it fits in the nanopore, thereby identifying the added base electronically. The circuitry in FIG. 5 maintains a constant voltage across nanopore 502 while the ion flow conductance is measured. In particular, the circuitry includes an operational amplifier 504 and a pass device 506 that maintain a constant voltage equal to Vₐ or V_{b} across the nanopore 502. The ion flow through nanopore 502 is integrated at a capacitor n_{cap} 508 and measured by an Analog-to-Digital (ADC) converter 510. The circuitry 500, however, only measures unidirectional current flow. Additionally, the temperature drift in the operational amplifier 504 may cause the actual voltage applied across nanopore 502 to vary across different electrochemical cells in an array. The actual voltage applied across nanopore 502 may drift by tens of millivolts above or below the desired value, thereby causing significant measurement inaccuracies. Shrinking the operational amplifier's size in a large-sized array may raise other performance issues.

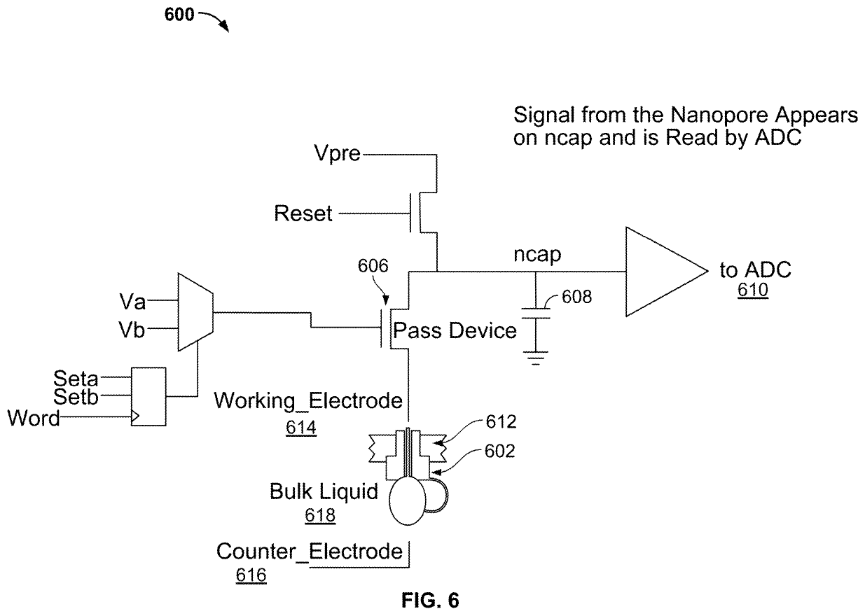

FIG. 6 illustrates an embodiment of circuitry 600 for use in an electrochemical cell of a nanopore based sequencing chip, wherein the voltage applied across the nanopore can be configured to vary over a time period during which the nanopore is in a particular detectable state. One of the possible states of the nanopore is an open-channel state when a no molecular moiety (e.g., a tag) is present in the barrel of the nanopore. Other possible states of the nanopore correspond to the states when the four different types of molecular moieties are present in the barrel of the nanopore. Yet another possible state of the nanopore is when the membrane is ruptured. FIG. 6 shows a nanopore 602 that is inserted into a membrane 612, and nanopore 602 and membrane 612 are situated between a cell working electrode 614 and a counter electrode 616, such that a voltage is applied across nanopore 602. Nanopore 602 is also in contact with a bulk liquid/electrolyte 618. Note that nanopore 602 and membrane 612 are drawn upside down as compared to the nanopore and membrane in FIG. 1. Hereinafter, an electrochemical cell is meant to include at least a membrane, a nanopore, a working electrode, and the associated circuitry. In some embodiments, the counter electrode is shared between a plurality of cells (e.g., in an array), and is therefore also referred to as a common electrode. The common electrode can be configured to apply a common potential to the bulk liquid in contact with the nanopores in the measurement cells. The common potential and the common electrode are common to all of the measurement cells. There is a metal working cell electrode within each measurement cell; in contrast to the common electrode, the metal working cell electrode 614 is configurable to apply a distinct potential that is independent from the working cell electrodes in other measurement cells.

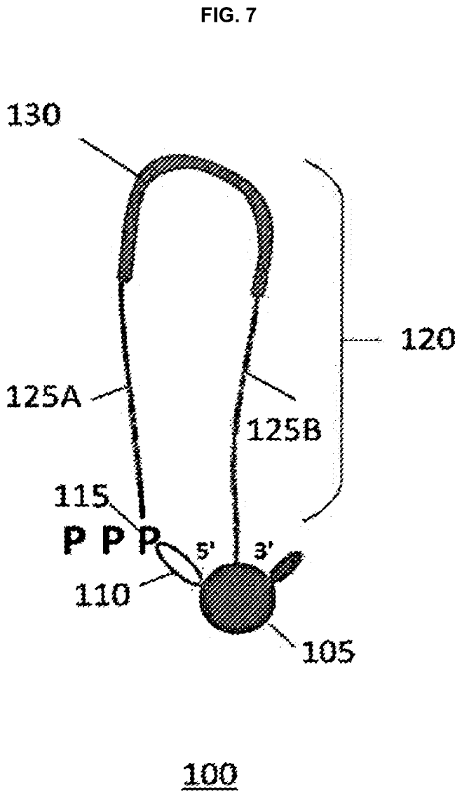

In addition to the Nano-SBS sequencing described above, in some embodiments, the electrochemical cells of the present disclosure can be used to carry out parallel sequencing of nucleic acids using a nanopore-based Sequencing-by-Expansion (Nano-SBX) technique. See, e.g., U.S. Pat. No. 7,939,259. The SBX technique is based on the polymerization of highly modified, non-natural nucleotide analogs referred to as “XNTPs”. In general terms, SBX uses biochemical polymerization to transcribe the sequence of a DNA template onto a measurable polymer called an “Xpandomer”. The transcribed sequence is encoded along the Xpandomer backbone in high signal-to-noise reporters that are separated by ~10 nm and are designed for high-signal-to-noise, well-differentiated responses. These differences provide significant performance enhancements in sequence read efficiency and accuracy of Xpandomers relative to natural DNA. A general description of the SBX process is depicted in FIGS. 7, 8, 9, and 10.

XNTPs are expandable, 5′ triphosphate modified non-natural nucleotide analogs compatible with template dependent enzymatic polymerization. A highly simplified XNTP is illustrated in FIG. 7, which emphasizes the unique features of these non-natural substrates: XNTP 100 has two distinct functional regions; namely, a selectively cleavable phosphoramidate bond 110, linking the 5′ α-phosphate 115 to the nucleobase 105, and a symmetrically synthesized reporter tether (SSRT) 120 that is attached within the nucleoside thiophosphoramidate at positions that allow for controlled expansion by cleavage of the phosphoramidate bond. The SSRT includes linkers 125A and 125B separated by the selectively cleavable phosphoramidate bond. Each linker attaches to one end of a reporter code 130. XNTP 100 is illustrated in the “constrained configuration,” characteristic of the XNTP substrates and the daughter strand products of template-dependent polymerization. The constrained configuration of polymerized XNTPs is the precursor to the expanded configuration, as found in Xpandomer products. The transition from the constrained configuration to the expanded configuration occurs upon scission of the P—N bond of the phosphoramidate within the primary backbone of the daughter strand.

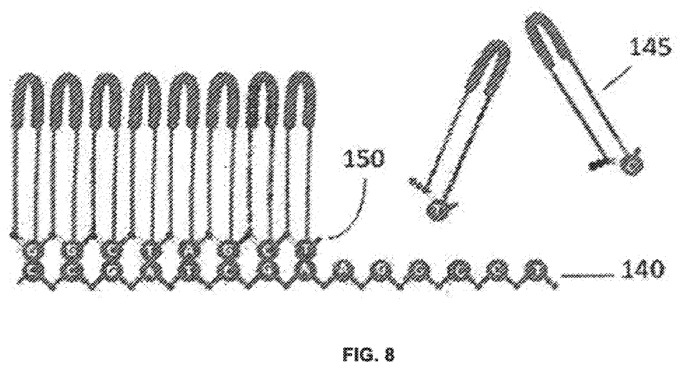

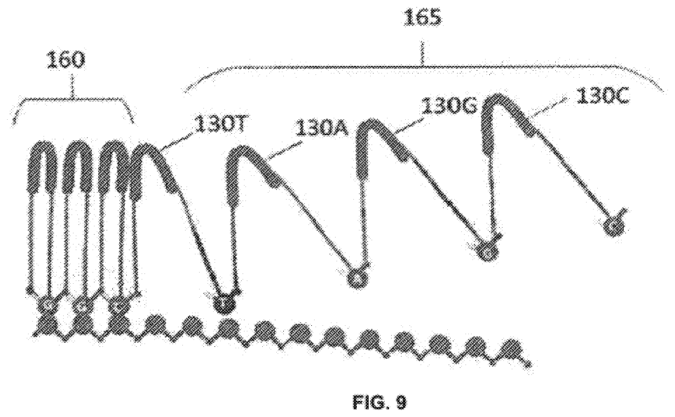

Synthesis of an Xpandomer polymer is summarized in FIGS. 8 and 9. As shown in FIG. 8, during assembly, the monomeric XNTP substrates 145 (XATP, XCTP, XGTP and XTTP) are polymerized on the extendable terminus of a nascent daughter strand 150 by a process of template-directed polymerization using single-stranded template 140 as a guide. Generally, this process is initiated from a primer and proceeds in the 5′ to 3′ direction. Generally, a DNA polymerase or other polymerase is used to form the daughter strand, and conditions are selected so that a complimentary copy of the template strand is obtained. After the daughter strand is synthesized, the coupled SSRTs form the constrained Xpandomer that further forms the daughter strand. SSRTs in the daughter strand have the “constrained configuration” of the XNTP substrates. The constrained configuration of the SSRT is the precursor to the expanded configuration, as found the Xpandomer product.

As shown in FIG. 9, the transition from the constrained configuration 160 to the expanded configuration 165 results from cleavage of the selectively cleavable phosphoramidate bonds (illustrated for simplicity by the unshaded ovals) within the primary backbone of the daughter strand. In this embodiment, the SSRTs include one or more reporters or reporter codes, 130A, 130C, 130G, or 130T, specific for the nucleobase to which they are linked, thereby encoding the sequence information of the template. In this manner, the SSRTs provide a means to expand the length of the Xpandomer and lower the linear density of the sequence information of the parent strand.

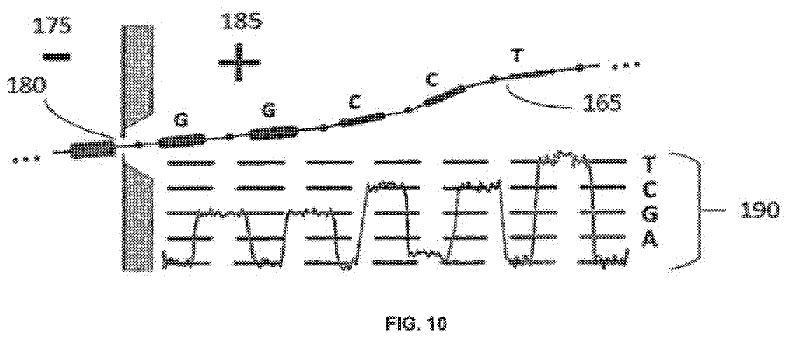

FIG. 10 illustrates an Xpandomer 165 translocating through a nanopore 180, from the cis chamber 175 to the trans chamber 185. Upon passage through the nanopore, each of the reporter codes of the linearized Xpandomer generates a distinct and reproducible electronic signal specific for the nucleobase to which it is linked. This signal is illustrated by superimposed trace 190.

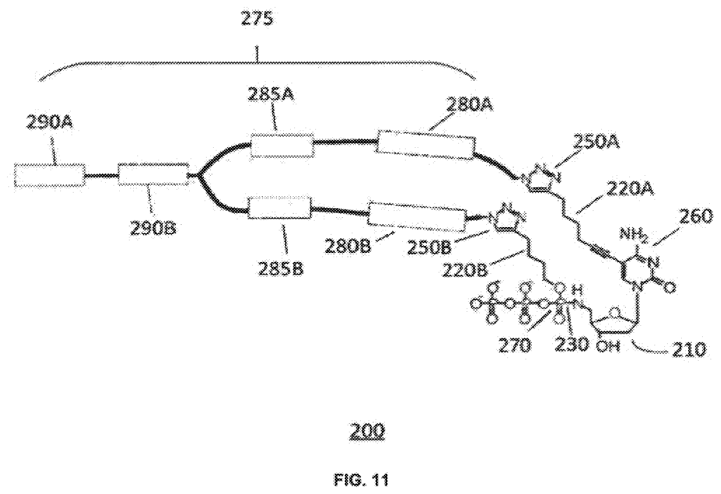

FIG. 11 depicts the generalized structure of one embodiment of an XNTP in more detail. XNTP 200 includes nucleoside triphosphoramidate 210 with linker arm moieties 220A and 220B separated by selectively cleavable phosphoramidate bond 230. An SSRT 275 is joined to the nucleoside triphosphoramidate at linkage groups 250A and 250B, in which a first SSRT end is joined to the heterocycle 260 (represented here by cytosine, though the heterocycle may be any one of the four standard nucleobases, A, C, G, or T) and a second SSRT end is joined to the α-phosphate 270 of the nucleobase backbone. The skilled artisan will appreciate that many suitable coupling chemistries known in the art may be used to form the final XNTP substrate product, for example, SSRT conjugation may be accomplished through formation of a triazole linkage group.

In this embodiment, SSRT 275 includes several functional elements, or “features” such as polymerase enhancement regions 280A and 280B, reporter codes 285A and 285B, and translation control element (TCEs) 290A and 290B. In other embodiments, the SSRT can include a single TCE. Each of these features performs a unique function during translocation of the Xpandomer through a nanopore to produce a series of unique and reproducible electronic signal. SSRT 275 is designed for controlling the rate of Xpandomer translocation by the TCE through a combination of steric hindrance and/or electro-repulsion, as discussed elsewhere herein. Different reporter codes are sized to block ion flow through a nanopore at different measurable levels.

Specific SSRT polymeric sequences can be efficiently synthesized using phosphoramidite chemistry typically used for oligonucleotide synthesis. Reporter codes and other features can be designed by selecting a sequence of specific phosphoramidites from commercially available and/or proprietary libraries. Such libraries include, but are not limited to, polyethylene glycol with lengths of 1 to 12 or more ethylene glycol units and aliphatic polymers with lengths of 1 to 12 or more carbon units. In certain embodiments, the SSRTs include features referred to as “polymerase enhancement regions” at the ends of the SSRTs proximal to the nucleotide triphosphoramidate diester. Polymerase enhancement regions may include positively charged polyamine spacers (e.g., primary, secondary, tertiary, or quaternary amines) or triamine spacers (three secondary amines each separated by three carbons) that facilitate incorporation of XNTP structures by a nucleic acid polymerase. In certain embodiments, the polymerase enhancement region includes two repeat units of spermine, in which the spermine moiety is provided by a phosphoramidite monomer having the following structure (as one of skill in the art will recognize, the trifluoroacetamide protecting groups are removed at the end of SSRT synthesis to expose the amine groups on spermine):

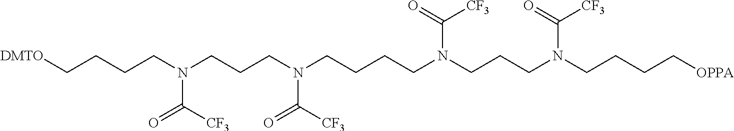

As used throughout the present disclosure, the term “reporter construct” refers to the element of the SSRT that includes the reporter codes, a symmetrical chemical brancher, and a translocation control element. In certain embodiments, the reporter construct is a polymer that includes, in series, from a first end to a second end, a first reporter code, a symmetrical chemical brancher bearing a translocation control element, and a second reporter code. The term “bearing” refers to a covalent linkage between the symmetrical brancher and the translocation control element, which produces an advantageous orientation of the translocation control element with respect to the two reporter codes. The symmetrical chemical brancher can be represented by the letter “Y”, in which the two reporter codes are joined to the arms of the Y, while the translocation control element is joined to the stem of the Y. Thus, the two reporter codes are joined in-line by the brancher, while the brancher bears the translocation control element in a perpendicular orientation with respect to the linear, in-line, SSRT.

As used throughout the present disclosure, the terms “linker A” and “linker B” refer to the regions of the SSRT that each include a polymerase enhancing region and one or more translocation deceleration features or regions, and, in certain embodiments, a spacer region that includes a polymer of, e.g., PEG6, which can be customized to modulate the length of the SSRT traversed in a nanopore.

In certain embodiments, an XNTP may be a compound having the following generalized structure:

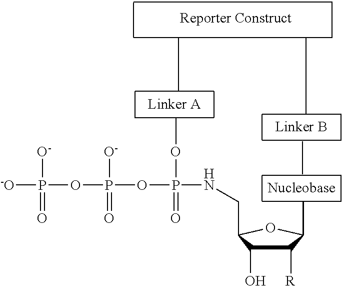

In one embodiment, R may be H, for example, when the compounds are used to sequence a DNA template. In another embodiment, R may be OH, for example, when the compounds are used to sequence an RNA template. In certain embodiments, nucleobase is adenine, cytosine, guanine, thymine, uracil or a nucleobase analog. As one of skill in the art will appreciate, adenine, cytosine, guanine, thymine, and uracil are naturally occurring nucleobases. As used herein, the term “nucleobase analog” refers to non-naturally occurring nucleobases that are capable of forming Watson and Crick base pair with a complementary nucleobase on an adjacent single-stranded nucleic acid template. Exemplary nucleobase analogs include, but are not limited to, 5-fluorouracil; 5-bromouracil, 5-chlorouracil, 5-iodouracil, hypoxanthine, xanthine, 4-acetylcytosine, 5-(carboxyhydroxylmethyl) uracil, 5-carboxymethylaminomethyl-2-thiouridine, 5-carboxymethylaminomethyluracil, dihydrouracil, beta-D-galactosylqueosine, inosine, N6-isopentenyladenine, 1-methylguanine, 1-methylinosine, 2,2-dimethylguanine, 2-methyladenine, 2-methylguanine, 3-methylcytosine, 5-methylcytosine, N6-adenine, 7-methylguanine, 5-methylaminomethyluracil, 5-methoxyaminomethyl-2-thiouracil, beta-D-mannosylqueosine, 5′-methoxycarboxymethyluracil, 5-methoxyuracil, 2-methylthio-N6-isopentenyladenine, uracil-5-oxyacetic acid (v), wybutoxosine, pseudouracil, queosine, 2-thiocytosine, 5-methyl-2-thiouracil, 2-thiouracil, 4-thiouracil, 5-methyluracil, uracil-5-oxyacetic acid methylester, uracil-5-oxyacetic acid (v), 5-methyl-2-thiouracil, 3-(3-amino-3-N-2-carboxypropyl) uracil, (acp3)w, 2,6-diaminopurine, 3-nitropyrrole, 8-aza-7-deazaguanine, 8-aza-7-deazainosine, and 8-aza-7-deazaadenine.

As discussed elsewhere herein, the reporter construct is a polymer having a first end and a second end, and includes, in series from the first end to the second end, the first reporter code, the symmetrical chemical brancher bearing the translocation control element, and the second reporter code. This series of features reflects the symmetrical structure of the reporter construct (and the entire SSRT, which includes the symmetrical linkers, linker A and linker B), in which the sequences of the two reporter codes are identical and joined, in-line in reverse orientation by the symmetrical chemical brancher. Briefly, synthesis proceeds in the 3′ to 5′ direction, initiating at the 3′ end of the TCE. Addition of the symmetrical brancher to the 5′ end of the TCE enables simultaneous polymerization of the first and second reporter codes off each arm of the brancher, followed by simultaneous synthesis of linker A and linker B, terminating at the 5′ end of the first end and the second end of the SSRT. It has been found that the in-line redundancy provided by two identical reporter codes separated by the symmetrical brancher bearing the translocation control element offers several advantages during nanopore sequencing. For example, Xpandomers can potentially be read by the nanopore when translocated in either direction, i.e., the Xpandomer can be read either “forwards” or “backwards”. This flexibility enables the “ratcheting” method of sequencing, which is discussed further herein, and other methods, such as “flossing” that are based on an AC pattern of voltage application.

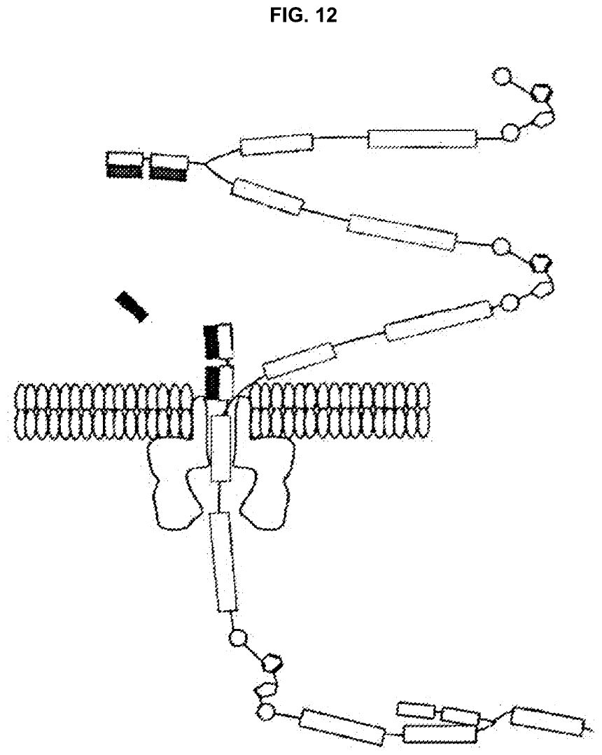

FIG. 12 shows one embodiment of a cleaved Xpandomer in the process of translocating a nanopore. The nanopore is embedded into a lipid bilayer membrane which separates and electrically isolates two chambers of electrolytes. A typical electrolyte has 1 M Ammonium chloride buffered to a pH between 6.0 and 8.0. When a small voltage, typically 85 mV, is applied across the bilayer, the nanopore provide the only channel for the flow of ions induced by the potential and is the source primary resistance in the circuit. Xpandomer reporter codes are designed to give specific ion flow blockage levels and sequence information can be read by measuring the sequence of ion flow levels as pulses in voltage potential result in a sequence of reporter codes translocating through the nanopore. In the case of an α-hemolysin nanopore, the nanopore is typically embedded in the membrane so that translocation occurs by entering the cis vestibule side and exiting the trans stem side. As shown in FIG. 12, the nanopore is oriented to capture the Xpandomer from the stem side first. As the Xpandomer translocates the nanopore, a reporter enters the stem until its translocation control element stops at the stem entrance. The reporter is held in the stem until the TCE is enabled to pass into and through the stem, whereupon translocation proceeds to the next reporter. In this embodiment, TCE passage into the stem is enabled by dissociation of a translocation control moiety from the TCE.

### EXAMPLES

Various features and embodiments of the disclosure are illustrated in the following representative examples, which are intended to be illustrative, and not limiting. Those skilled in the art will readily appreciate that the specific examples are only illustrative of the invention as described more fully in the claims which follow thereafter. Every embodiment and feature described in the application should be understood to be interchangeable and combinable with every embodiment contained within.

### Example 1: Synthesis of Triblock Copolymers with Modified Headgroups

This example illustrates the synthesis of various triblock copolymer compounds with modified headgroups used in the lipid bilayers with embedded nanopores of the present disclosure.

### A. Synthesis of the α,ω-(hydroxy-, 2-methyl-2-oxazolinium triflate)-terminated poly(2-methyl-2-oxazoline)-block-polydimethylsiloxane-block-poly(2-methyl-2-oxazoline)

This member of the PMOXA-PDMS-PMOXA family of “living” triblock copolymer (TBC) compounds has the structural formula shown in Scheme 1 and is a precursor for the synthesis of the other α,ω-(hydroxyl-/methyl ester-)- and α,ω-(hydroxyl-/azide-)-terminated TBC compounds described below.

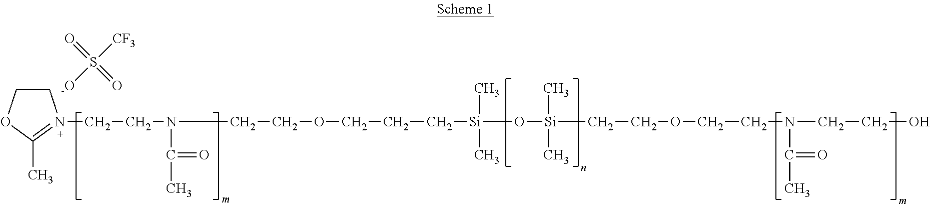

The synthesis of the Scheme 1 TBC compound generally follows that described by Lörcher, S.; Meier, W. “Cosolvent fractionation of PMOXA-b-PDMS-b-PMOXA: Bulk separation of triblocks from multiblocks.” European Polymer Journal 2017, 88, 575-585, and was carried out as follows. 6.42 g (2.29 mmol, Mn₁_{_{H-NMR}}=2800 g/mol) dry α,ω-bis(carbinol)-terminated polydimethylsiloxane and 0.67 mL (4.84 mmol) dry triethylamine were dissolved in 100 mL dry hexane and cooled to −25° C. A solution of 0.83 mL (4.91 mmol) trifluoromethanesulfonic anhydride in 15 mL dry hexane was added dropwise to the cooled polydimethylsiloxane solution. The reaction mixture was stirred at −25° C. for 3 h under inert atmosphere. The formed triethylammonium trifluoromethanesulfonate precipitate was filtered off at −20° C. under inert atmosphere and hexane was evaporated at RT and 0.3 mbar. The resulted α,ω-bis(triflate)-terminated polydimethylsiloxane was further dried at 30° C. and 0.3 mbar for 1 h and then 45 mL dry chloroform, 19 mL dry acetonitrile and 3.3 mL (38.9 mmol) dry 2-methyl-2-oxazoline were added. The reaction mixture was kept for 65 h at 42° C. under inert atmosphere and then passive cooled to RT. The polymerization was terminated before full monomer conversion using various terminating agents (nucleophiles) under established reaction conditions.

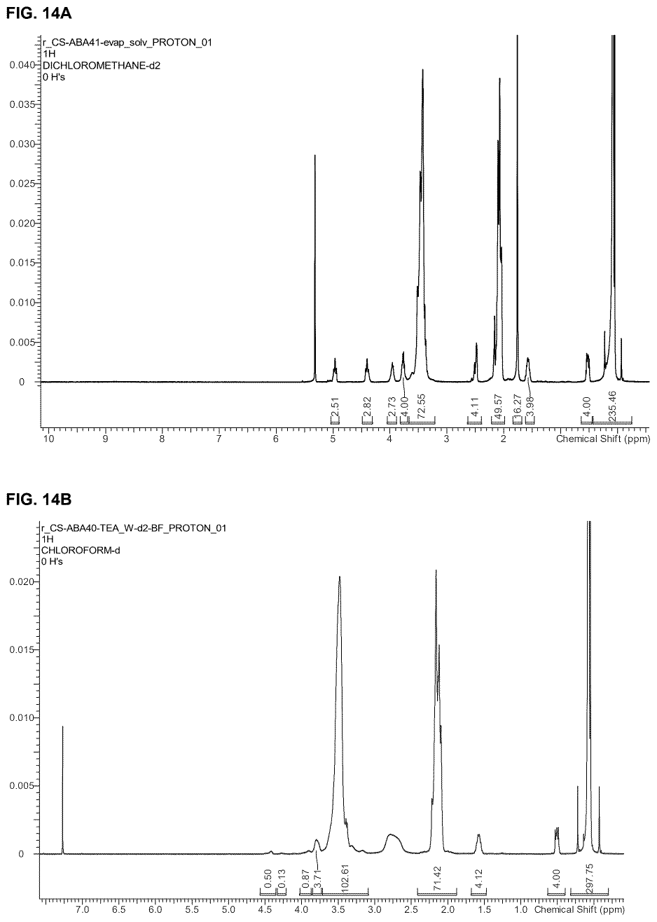

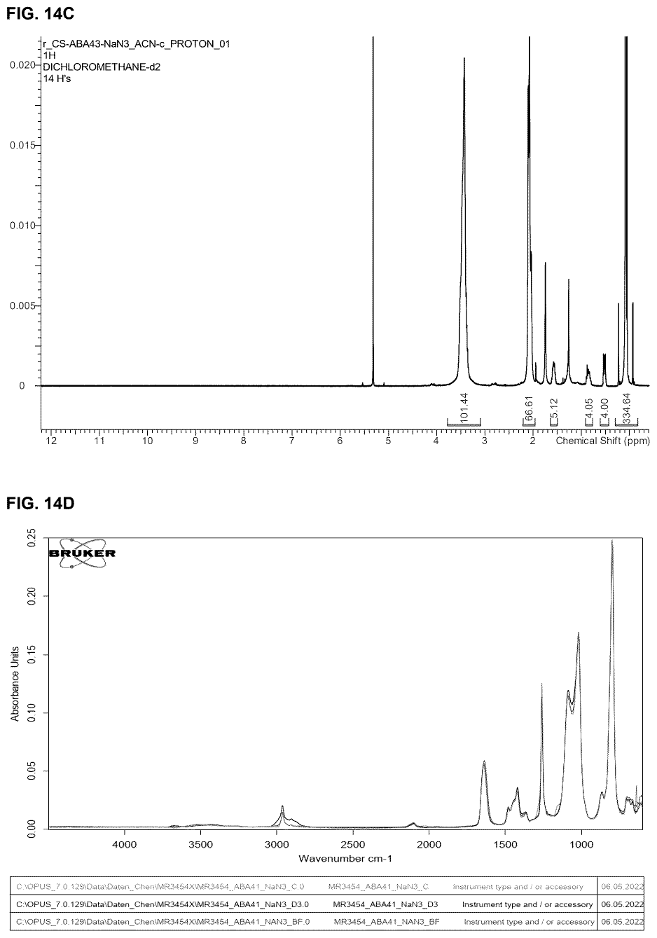

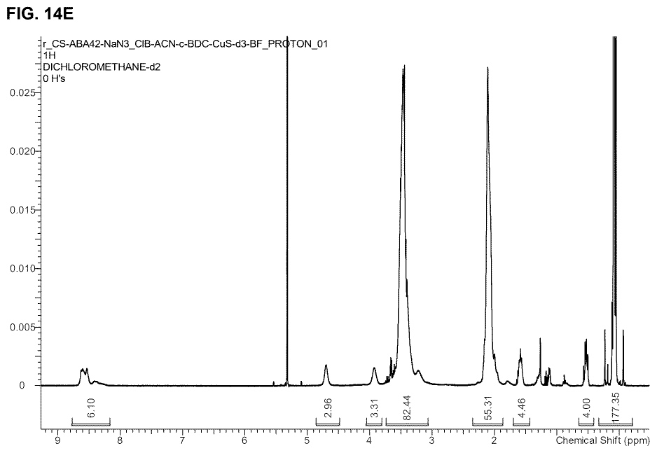

¹H-NMR (400 MHz, CD₂Cl₂, δ) parameters for the “living” polymer of Scheme 1 resulting from the polymerization are: 4.97 (t, 2.51H, —CH₂— vicinal to —N⁺═ in 2-methyl-2-oxazolinium triflate head-group), 4.40 (t, 2.82H, —CH₂— vicinal to —O— in 2-methyl-2-oxazolinium triflate head-group), 3.96 (br, 2.73H, —CH₂— vicinal to —N⁺═ in 2-methyl-2-oxazolinium triflate head-group), 3.85-3.70 (br, 4H, —CH₂— vicinal to —OH overlaps with —CH₂— vicinal to —CH₂—OH), 3.7-3.2 (br, 72.55H, —CH₂—CH₂— vicinal to —NC(O)CH₃ of the PMOXA backbone overlaps with —CH₂— from —CH₂—CH₂—O—CH₂—CH₂—CH₂— linker), 2.48 (br, 4.11H, —CH₃ in 2-methyl-2-oxazolinium triflate head-group), 2.26-1.98 (br, 49.57H, —CH₃ in 2-methyl-2-oxazoline side-chain), 1.63-1.5 (br, 3.98H, —CH₂— vicinal to —CH₂—Si(—CH₃)₂—O—), 0.59-0.47 (m, 4H(ref.), —CH₂— vicinal to —Si(—CH₃)₂—O—) and 0.08 (br, 235.46H, CH₃— of the PDMS backbone) all in ppm, as presented in FIG. 14A.

### B. Synthesis of α,ω-(acetyloxy-hydroxy-)-terminated poly(2-methyl-2-oxazoline)-block-polydimethylsiloxane-block-poly(2-methyl-2-oxazoline)

This member of the PMOXA-PDMS-PMOXA family of TBC compounds has the structural formula shown in Scheme 2 and is referred to herein as “Ch111-type” TBC.

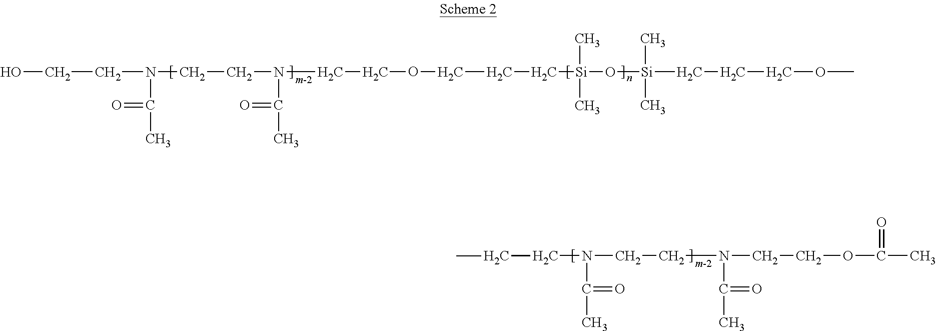

The polymerization of 2-methyl-2-oxazoline was terminated by adding triethylamine: water (1:4 v/v), where triethylamine was 4.3 molar equivalents of the polydimethylsiloxane macro-initiator, and mixing for 18 h at RT. The volatiles were evaporated and the polymer was dried for 3 h at 50° C. and 0.3 mbar. The polymer was dissolved in water: ethanol (1:1 v/v, 7 mg/mL) and the low molecular weight ethanol/water-soluble impurities were removed by ultrafiltration (e.g., dialysis with ethanol: water (1:1 v/v) using a centrifugal filter having a regenerated cellulose membrane with a 2 kDa MWCO). Water and ethanol were evaporated after ultrafiltration and the polymer was dried for 3 h at 50° C. and 0.3 mbar. The dialyzed polymer was co-solvent fractionated by dissolving it in methanol: hexane (1:1, 6 mg/mL) and mixing the solution for 18 h at RT and for 3 h at −60° C. The cooled solution was left to warm to RT in a separatory funnel until clear phase separation. The bottom fraction was collected, solvents were evaporated and the polymer was dried for 3 h at 50° C. and 0.3 mbar.

¹H-NMR (400 MHz, CDCl₃, δ) parameters determined for the Ch111 TBC compound prepared above are: 4.38 (br, 0.71H, —CH₂— vicinal to —COOCH₃), 3.77 (br, 3.92H, —CH₂— vicinal to —OH), 3.68-3.25 (br, 98.24H, —CH₂—CH₂— vicinal to —NC(O)CH₃ of the PMOXA backbone overlaps with —CH₂— vicinal to —CH₂—OH, —CH₂— vicinal to —CH₂—COOCH₃ and —CH₂— vicinal to —CH₂—CH₂—Si(—CH₃)₂—O—), 2.2-2.04 (br, 67.93H, —NC(O)CH₃), 1.65-1.5 (br, 4.51H, —CH₂— vicinal to —CH₂—Si(—CH₃)₂—O—), 0.55-0.45 (m, 4H(ref.), —CH₂— vicinal to —Si(—CH₃)₂—O—) and 0.07 (br, 309.71H, CH₃— of the PDMS backbone) all in ppm, as presented in FIG. 14B.

### C. Synthesis of α,ω-(azide-hydroxy-)-terminated poly(2-methyl-2-oxazoline)-block-polydimethylsiloxane-block-poly(2-methyl-2-oxazoline)

This member of the PMOXA-PDMS-PMOXA family of TBC compounds has the structural formula shown in Scheme 3, and is a precursor used for preparation via CuAAC click-chemistry of TBC compounds with modified head-groups described below.

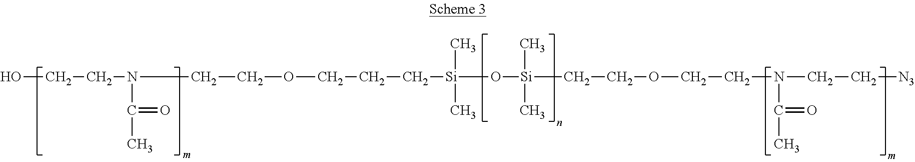

The reaction solvents (e.g. chloroform and acetonitrile) were evaporated under Schlenk conditions and the resulting α,ω-bis(2-methyl-2-oxazolinium triflate)-terminated poly(2-methyl-2-oxazoline)-block-polydimethylsiloxane-block-poly(2-methyl-2-oxazoline) “living” polymer was dried for ca. 30 min at 30° C. and 0.03 mbar. The dried solid “living” polymer was re-dissolved in acetonitrile (ca. 90 mg/mL) and further mixed with sodium azide (1 equivalent of PDMS to 70 equivalents of sodium azide) for 45 h at 80° C. under inert atmosphere. The reaction mixture was cooled down to RT, then the unreacted sodium azide was filtered off and the solvent was evaporated. The resulted polymer was re-dissolved in ethanol and the precipitated sodium azide was removed by centrifugation. Finally, ethanol was evaporated and the resulted polymer was dried for 1 h at 30° C. and 1 mbar, then stored at −20° C. before use.

¹H-NMR (400 MHz, CD₂Cl₂, δ) parameters determined for the resulting α,ω-(azide-, hydroxy-)-terminated poly(2-methyl-2-oxazoline)-block-polydimethylsiloxane-block-poly(2-methyl-2-oxazoline) were: 3.7 (br, —CH₂-vicinal to —OH overlaps with —CH₂—CH₂— from the PMOXA backbone), 3.76-3.15 (br, 101.14H, —CH₂—CH₂— vicinal to —NC(O)CH₃ of the PMOXA backbone overlaps with —CH₂— vicinal to —CH₂—OH, —CH₂— vicinal to —OH, —CH₂— vicinal to —N₃ and —CH₂— vicinal to —CH₂—CH₂—Si(—CH₃)₂—O—), 2.22-1.96 (br, 66.61H, —NC(O)—CH₃), 1.64-1.50 (br, 5.12H, —CH₂— vicinal to —CH₂—Si(—CH₃)₂—O—), 0.58-0.46 (m, 4H(ref.), —CH₂— vicinal to —Si(—CH₃)₂—O—) and 0.08 (br, 334.64H, CH₃— of the PDMS backbone). An exemplary NMR spectrum is depicted in FIG. 14C. FT-IR spectra (shown in FIG. 14D) were obtained for the α,ω-(azide-, hydroxy-)-terminated poly(2-methyl-2-oxazoline)-block-polydimethylsiloxane-block-poly(2-methyl-2-oxazoline) after solvent evaporation (grey), ultrafiltration (blue) and co-solvent fractionation (red). The azide head-groups can be depicted at ca 2100 cm⁻¹ in all samples.

### D. Synthesis α,ω-(hydroxy-, 5-(1-polymer-1H-1,2,3-triazol-4-yl)isophthalic acid)-terminated poly(2-methyl-2-oxazoline)-block-polydimethylsiloxane-block-poly(2-methyl-2-oxazoline) Via CuAAC

This member of the PMOXA-PDMS-PMOXA family of TBC compounds has the structural formula shown in Scheme 4 and is referred to herein as “Ch127/128-type” TBC.

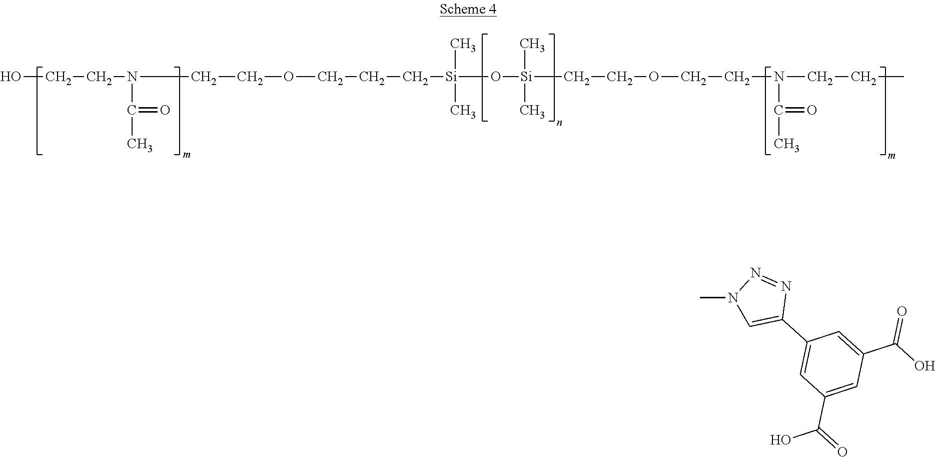

Although CuAAC reactions conditions (use of ethanol and copper nanoparticles, reaction time and temperature) have been reported for the PMOXA-PDMS-PMOXA synthesis (using a α,ω-bis(azide)-terminated PDMS and alkyne-terminated PMeOxa) (see e.g., Isaacman, M. J.; Barron, K. A.; Theogarajan, L. S. Clickable amphiphilic triblock copolymers. Journal of Polymer Science Part A: Polymer Chemistry 2012, 50 (12), 2319-2329), CuAAC has not previously been reported for modification of a TBC headgroup.

The CuAAC based synthesis of the Ch127/128 type polymers was carried out as follows. 0.45 g (0.1 mmol) α,ω-(azide-, hydroxy-)-terminated poly(2-methyl-2-oxazoline)-block-polydimethylsiloxane-block-poly(2-methyl-2-oxazoline) and 0.54 g (2.85 mmol) of an alkyne, in this example 5-ethynyl-1,3-benzenedicarboxylic acid, were dissolved in 4 mL ethanol, and the resulted solution was purged with inert gas for 30 min. After purging, 60-100 mg copper nanoparticles (size of 25 to 60 nm) were added to the polymer solution under inert atmosphere and the reaction mixture was stirred for 2 to 3 h at 60° C. under inert atmosphere. After cooling to RT, the reaction mixture was diluted with ethanol and copper nanoparticles were removed by centrifugation. The traces of copper were further removed by passing the polymer solution through a copper scavenger column several times. The unreacted alkyne and ethanol/water-soluble impurities were removed by ultrafiltration (e.g., dialysis with ethanol:water (0.8:0.2 to 1:1 v/v) using a centrifugal filter having a regenerated cellulose membrane with a 2 kDa MWCO). Water and ethanol were evaporated after ultrafiltration and the polymer was dried for 3 h at 50° C. and 0.3 mbar. The dialyzed polymer was co-solvent fractionated by dissolving it in methanol: hexane (1:1; 6 mg/mL) and mixing the solution for 18 h at RT and for 3 to 5 h at −60° C. The cooled solution was left to warm at RT in a separatory funnel until clear phase separation. The bottom fraction was collected, solvents were evaporated and the polymer was dried for 3 h at 50° C. and 0.3 mbar.

¹H-NMR (400 MHz, CD₂Cl₃, δ) of the CH127/128-type polymer described above: 8.7-8.2 (br, 6.1H, aromatic protons from triazole and aromatic ring), 4.7 (br, 2.96H, —CH₂— next to triazol), 3.93 (br, 3.31H, —CH₂— next to —CH₂— triazol), 3.79-2.95 (br, 82.44H, —CH₂—CH₂— vicinal to —NC(O)CH₃ of the PMOXA backbone overlaps with —CH₂— from —CH₂—CH₂—O—CH₂—CH₂—CH₂— linker), 2.32-1.86 (br, 55.31H, —NC(O)—CH₃), 1.68-1.48 (br, 4.46H, —CH₂— vicinal to —CH₂—Si(—CH₃)₂—O—), 0.59-0.46 (m, 4H(ref.), —CH₂— vicinal to —Si(—CH₃)₂—O—) and 0.08 (br, 177.35H, CH₃— of the PDMS backbone) all in ppm. An exemplary NMR spectrum is provided in FIG. 14E.

Table 2 (below) provides alkynes that can be used in the synthesis of additional PMOXA-PDMS-PMOXA TBCs of different MW and PDMS content and different head groups.

TABLE 2
Alkynes used in CuAAC with TBC-azide and the corresponding TBCs properties

| | | | | | Avg |
|---|---|---|---|---|---|
| | | | | | polymer |
| | | Funct. | | | size |
| | | deg. | MW | PDMS | (PMOXA- |
| Ch | | w/ Alkyne, | TBC, | content, | PDMS- |
| no. | Alkyne used in CuAAC | mol % | g/mol | wt % | PMOXA) |
| 118 | Propargyl alcohol | 77.0 | 4201 | 65 | 9-37-9 |
| 122 | 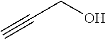 | 94.0 | 5014 | 60 | 12-41-12 |
| 112 | Hexynyl-PE | 57.5 | 4120 | 64 | 9-36-9 |
| 113 114 | 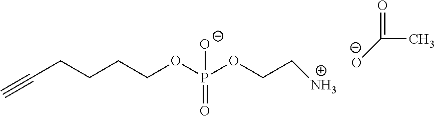 | 67.5 82.0 | 4611 6087 | 67 67 | 9-42-6 12-55-12 |
| 119 | 3-(dimethyl(prop-2-yn-1- | 79.5 | 4404 | 63 | 10-38-10 |
| 123 | yl)ammonio) | 90.0 | 4588 | 57 | 12-37-12 |
| | propane-1-sulfonate | | | | |
| | 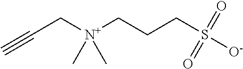 | | | | |
| 115 | 5-Hexynoic acid | 75.5 | 4333 | 67 | 9-39-9 |
| 116 | 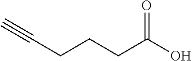 | 89.0 | 5445 | 66 | 11-49-11 |
| 120 | sodium 2-propyne-1-sulfonate | 79.0 | 4597 | 64 | 10-40-10 |
| 124 | 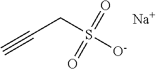 | 86.5 | 5359 | 62 | 12-45-12 |
| 125 | oct-7-yn-1-amine | 77.0 | 3936 | 59 | 10-31-10 |
| 126 | 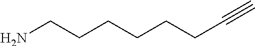 | 82.0 | 4654 | 58 | 11-37-11 |
| 127 | 5-ethynyl-1,3-benzenedicarboxylic acid | 76.3 | 3756 | 58 | 9-30-9 |
| 128 | 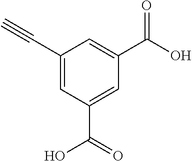 | 92.0 | 3803 | 47 | 12-24-12 |
| 129 | pent-4-yn-1-yl dihydrogen phosphate | 81.0 | 4524 | 50 | 13-31-13 |
| 130 | 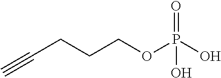 | 78.0 | 4960 | 59 | 12-40-12 |
| 131 | 2-(hept-6-yn-1-yl)propanedioic acid | 84.5 | 4050 | 60 | 9-33-9 |
| 132 | 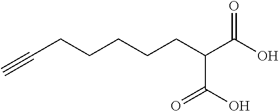 | 91.0 | 4481 | 57 | 11-34-11 |
| 133 | (2R)-2-(pent-4- | 54.0 | 3955 | 61 | 9-32-9 |
| 134 | ynamido)butanedioic acid | 67.0 | 4407 | 56 | 11-33-11 |
| | 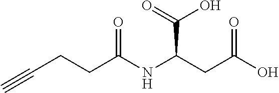 | | | | |
| 135 | (S)-2-Aminohept-6-ynoic acid | 60.0 | 4396 | 65 | 9-39-9 |
| 136 | 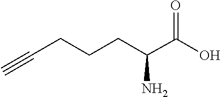 | 64.0 | 4571 | 59 | 11-36-11 |
| 137 | 7-(diethylamino)-2-oxo-N-(prop-2- | 75 | 5100 | 69 | 9-47-9 |
| 138 | yn-1-yl)-2H-chromene-3-carboxamide | 88 | 6800 | 68 | 13-62-13 |
| | 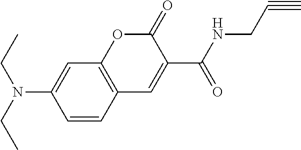 [SMILES: C#CCNC(=O)c1cc2ccc(N(CC)CC)cc2oc1=O] | | | | |

The various alkynes shown in Table 1 can be used in the CuAAC-based synthesis with α,ω-(azide-, hydroxy-)-terminated PMOXA-PDMS-PMOXA to provide the various TBCs with different terminal head groups comprising a triazole group shown below in Schemes 5-17. The reaction conditions used are as described above for CuAAC with 5-ethynyl-1,3-benzenedicarboxylic acid.

### Scheme 5. Chemical Structure of Ch118/122

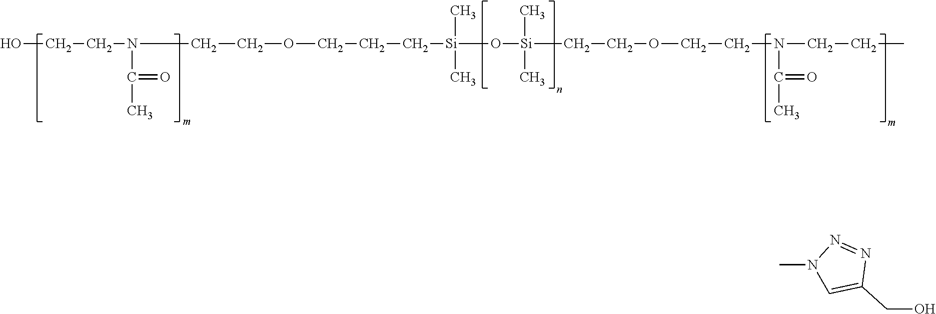

### Scheme 6. Chemical Structure of Ch112/113/114

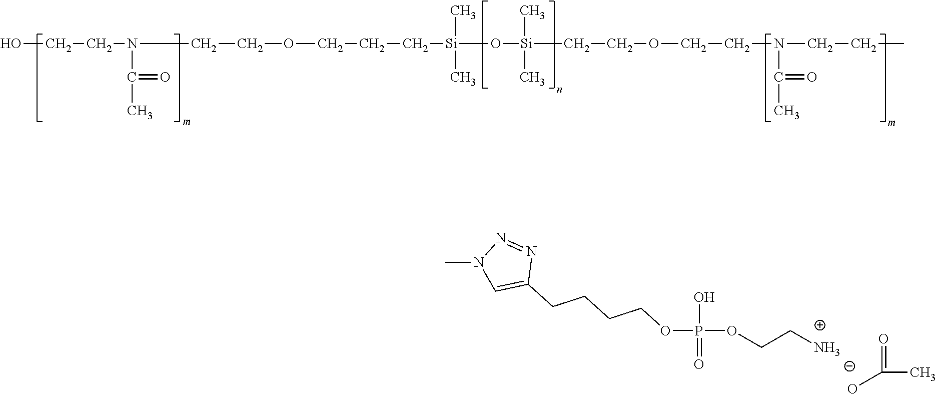

### Scheme 7. Chemical Structure of Ch119/123s

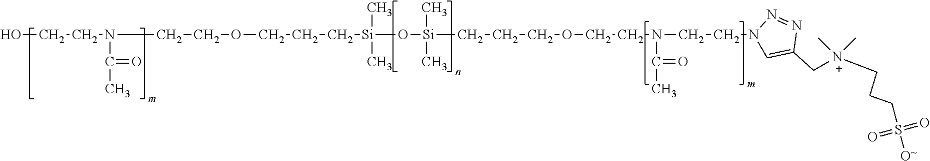

### Scheme 8. Chemical Structure of Ch115/116

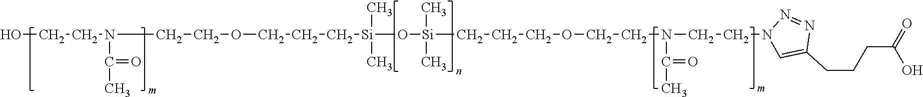

### Scheme 9. Chemical Structure of Ch120/124

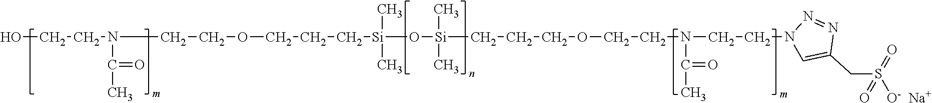

### Scheme 10. Chemical Structure of Ch125/126

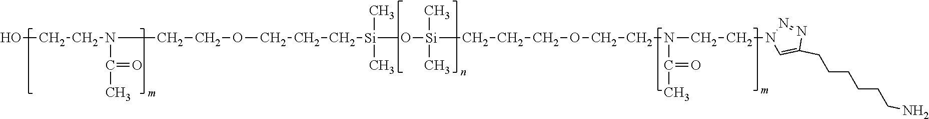

Scheme 11. Chemical Structure of TBC with Phosphate Head-Group—Ch129/Ch130

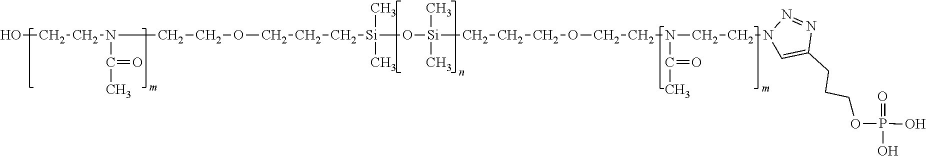

Scheme 12. Chemical Structure of TBC with -Propanedioic Acid Head-Group—Ch131/Ch132

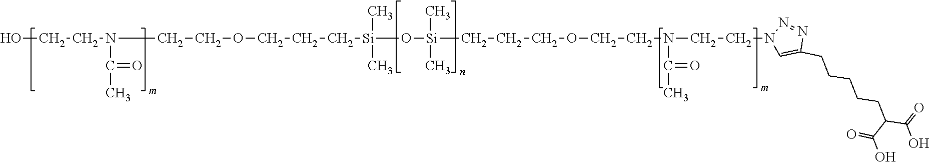

Scheme 13. Chemical Structure of TBC with -Butanedioic Acid Head-Group—Ch133/Ch134

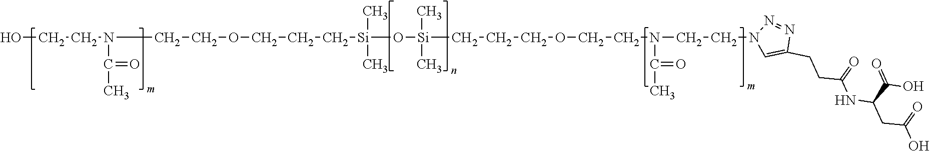

Scheme 14. Chemical Structure of TBC with Aminoheptynoic Acid Head-Group—Ch135/Ch136

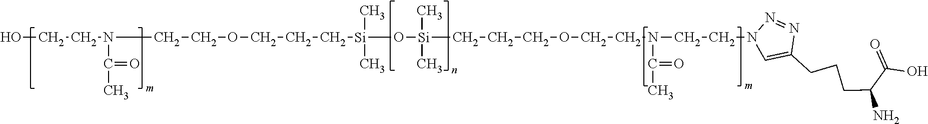

Scheme 15. Chemical Structure of TBC with Octynoic Acid Head-Group—Next Synthesis

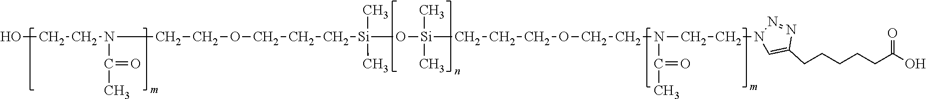

### Scheme 16. Chemical Structure of Ch108-Type TBC

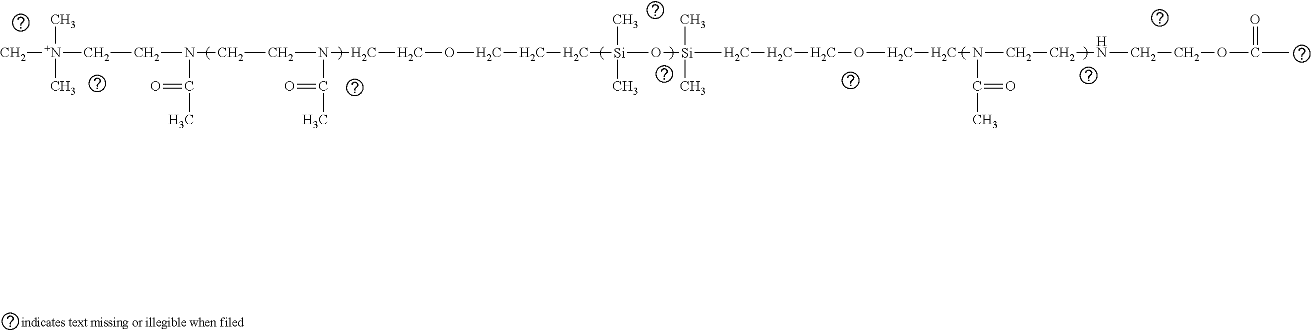 [SMILES: CC(=O)OCCNCCN(CCOCCC[Si](C)(C)O[Si](C)(C)CCCOCCN(CCN(CC[N+](C)(C)C)C(C)=O)C(C)=O)C(C)=O]

### Scheme 17. Chemical Structure of Ch137 and Ch138-Type TBC

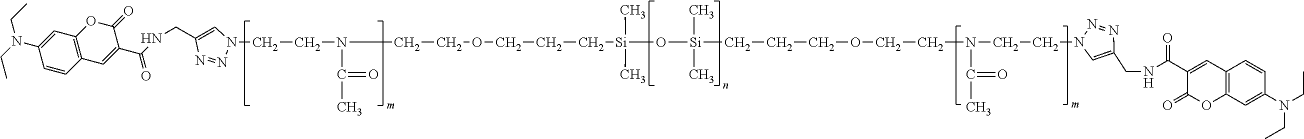

### Example 2: Use of Hybrid Triblock Copolymer (TBC) Lipid Bilayers in Nanopore-Based Nucleic Acid Detection

This example illustrates studies of the use of a hybrid triblock copolymer (TBC) lipid bilayers in electrochemical cells during SBX nanopore sequencing. A series of experiments were carried out that show the effects of the size and concentration of the triblock copolymer on sequencing results.

### Materials and Methods

A. Preparation of DPhPE/TBC solution: In a vial, a mass of 30 mg of DPhPE is dissolved in 10 mL of a 9:1 mixture of PDM20 silicone oil:hexadecane. The solution is swirled and sonicated at ambient temperature until fully dissolved to give a solution of 3 mg/mL DPhPE in 9:1 silicone oil:hexadecane. In a separate vial, 9 mg of PMOXA-PDMS-PMOXA TBC is added. To the solid, 2.7 mL of PDM20 silicone oil is added, followed by 0.3 mL of hexadecane. The resulting suspension is then sonicated at ambient temperature for 1 hour or until fully dissolved to afford a solution of 3 mg/mL copolymer in 9:1 silicone oil:hexadecane. To make a solution of 15% TBC and 85% DPHPE, 150 μL of 3 mg/mL polymer solution is added to 850 μL of 3 mg/mL lipid solution.

B. Preparation of electrochemical cells with nanopore-embedded hybrid lipid bilayers: The preparation of nanopore-embedded lipid bilayers in place on an array of electrochemical cells for nanopore-based sequencing has been described in e.g., U.S. Patent Application Publication Nos. 2013/0244340 A1, and US2014/0134616 A1. The standard nanopore-embedded bilayer preparation utilizes DPhPE lipid as the sole component for membrane formation and subsequent sequencing. The present example uses a hybrid bilayer forming solution that includes the standard DPhPE lipid and varying amounts of a synthetic triblock copolymer compound as described above. The resulting hybrid lipid/TBC solution is mixed with α-hemolysin nanopore and used to form a hybrid lipid bilayer on the electrochemical cell array according to standard methods (see e.g., US2013/0244340 A1)

### C. Nanopore-Based SBX Sequencing Using Hybrid Lipid Bilayers:

Nanopore-based SBX sequencing experiments are carried out using an array of electrochemical cells containing a buffer solution containing ferricyanide and ferrocyanide ions as described in e.g., U.S. Pat. No. 7,939,259, WO2020236526A1, and U.S. Ser. No. 63/337,413, filed May 2, 2022. The primary change in protocol is the composition of the membrane solution used to insert a biological nanopore and perform a sequencing experiment. Varying the properties of the triblock copolymer and amount added relative to DPhPE can result in different sequencing properties as detailed below.

A series of nanopore-based SBX sequencing experiments were carried out over the course of several months using arrays of electrochemical cells with nanopores embedded in standard phospholipid bilayers and compared to arrays with nanopores embedded in hybrid triblock copolymer lipid bilayers (Table 3, Experiments 1 through 8).

### Table 3: Relative Concentrations and Properties of Various Unmodified Polymers Initially Screened in SBX Sequencing Experiments

TABLE 3
Relative concentrations and properties of various unmodified
polymers initially screened in SBX sequencing experiments

| | | Avg polymer | Cell with | Number of | |
|---|---|---|---|---|---|
| | | size | Functional | Molecules | |
| | | (PMOXA- | Sequencing | Sequenced | Sequenced |
| | Headgroup | PDMS- | (200x | (200x | Molecules/ |
| | Modification | PMOXA) | subsampled) | subsampled) | min/cell |
| Experiment 1 | | | | | |
| None | None | N/A | 8214 | 3325363 | 10.07 |
| 2% Ch111 | Standard | 12-50-12 | 6431 | 3217682 | 13.96 |
| 10% Ch111 | Standard | 12-50-12 | 6261 | 4050181 | 19.89 |
| Experiment 2 | | | | | |
| None | None | N/A | 5018 | 1995591 | 9.74 |
| 2% Ch104 | Standard | 12-53-12 | 4087 | 1616074 | 10.12 |
| 10% Ch104 | Standard | 12-53-12 | 4502 | 2757675 | 16.76 |
| Experiment 3 | | | | | |
| None | None | N/A | 7502 | 2988529 | 9.98 |
| 2% Ch103 | Standard | 9-37-9 | 6626 | 2354889 | 10.08 |
| 10% Ch103 | Standard | 9-37-9 | 6894 | 3879636 | 16.77 |
| Experiment 4 | | | | | |
| None | None | N/A | 4337 | 1236610 | 6.90 |
| 10% Ch111 | Standard | 12-50-12 | 2975 | 1376338 | 12.98 |
| 15% Ch111 | Standard | 12-50-12 | 4722 | 2267012 | 14.34 |
| 20% Ch111 | Standard | 12-50-12 | 5392 | 2407190 | 12.49 |
| Experiment 5 | | | | | |
| 10% Ch111 | Standard | 12-50-12 | 4062 | 1733006 | 12.28 |
| 10% Ch42 | Standard | 11-40-11 | 2090 | 664964 | 7.98 |
| 10% Ch67 | Standard | 9-37-9 | 1212 | 531283 | 11.41 |
| 10% Ch71 | Standard | 5-18-5 | 2203 | 611916 | 7.97 |
| Experiment 6 | | | | | |
| 15% Ch111 | Standard | 12-50-12 | 6728 | 2248833 | 9.76 |
| 15% Ch110 | Standard | 11-49-11 | 7042 | 2057776 | 8.09 |
| 15% Ch93 | Standard | 11-53-11 | 5095 | 1979802 | 9.65 |
| 15% Ch109 | Standard | 13-52-13 | 6990 | 1984659 | 7.74 |
| Experiment 7 | | | | | |
| 15% Ch03 | Standard | 12-21-12 | 5196 | 4773593 | 19.25 |
| 15% Ch05 | Standard | 8-34-8 | 4934 | 4210544 | 15.43 |
| 15% Ch15 | Standard | 7-21-7 | 7577 | 8555457 | 18.62 |
| Experiment 8 | | | | | |
| 15% Ch20 | Standard | 9-30-9 | 6174 | 5577537 | 16.45 |
| 15% Ch72 | Standard | 5-17-5 | 3206 | 3824539 | 16.58 |
| 15% Ch74 | Standard | 4-18-4 | 4494 | 4800372 | 17.99 |

Results: It was found that cell failures due to non-sequencing “proto-pore” formation were reduced by at least two-fold when nanopores are embedded in a hybrid triblock copolymer lipid bilayer. In some cases, utilization of a particular polymer additive may completely remove the non-sequencing “proto-pore” population that could be up to 50% of potential pores when using a lipid only membrane.

Initial testing in Table 3, Experiment 1 indicated that addition of polymer Ch111 in varying amounts to the DPhPE lipid could afford an increase in sequencing throughput as measured by sequenced molecules per minute per cell. With standard DPhPE membrane only, a rate of approximately 10 molecules per minute was realized. At a 10% composition (or 0.3 mg/mL Ch111+2.7 mg/mL DPhPE) an improved rate of greater than 19 sequenced molecules per minute per cell. The net result was an increase in the total molecules sequenced, even though the DPhPE alone had more cells performing sequencing. Testing of alternative polymers (e.g. Experiment 2 and Experiment 3) revealed that this was consistent for other polymer sizes and that gains in sequencing throughput (as measured either as total molecules sequenced or sequenced molecules per minute per cell) and in particular these benefits could be realized at a composition of 10% polymer relative to DPhPE lipid. Testing of a higher concentration (Experiment 4) displayed 15% polymer composition to be optimal for improved throughput relative to other conditions when utilizing polymer Ch111. Experiments 5 through 8 display properties of other polymer species where different monomer amounts were varied and impacts in sequencing observed, particularly for throughput and cells performing sequencing. Notable results include Ch15 affording a higher level of cells performing sequencing and improved throughput relative to other polymers when using a (PMOXA)₇-(PDMS)₂₁-(PMOXA)₇ scaffold. Use of smaller scaffolds (e.g., Ch72 and Ch74 in Experiment 8) resulted in decrease in cells performing sequencing and molecules sequenced per minute per cell relative to Ch15. Experiment 6 displays that polymers of similar size also display similar results in throughput.

Our next set of experiments looked at headgroup modification of the polymer. Novel synthetic methods for PMOXA-PDMS-PMOXA polymers were utilized to generate an azide containing polymer that could be modified via reaction with alkyne species to enable headgroup modification. A series of sequencing experiments was performed with these polymers as a hybrid composition to determine sequencing properties as referenced in Table 4.

### Table 4: Relative Concentrations and Properties of Various Headgroup Modified Polymers Initially Screened in SBX Sequencing Experiments.

TABLE 4
Relative concentrations and properties of various headgroup modified
polymers initially screened in SBX sequencing experiments.

| | | Avg | | | |
|---|---|---|---|---|---|
| | | polymer | Cell with | Number of | |
| | | size | Functional | Molecules | |
| | | (PMOXA- | Sequencing | Sequenced | Sequenced |
| | | PDMS- | (200x | (200x | Molecules/ |
| | Terminal Headgroup | PMOXA) | subsampled) | subsampled) | min/cell |
| Experiment 1 | | | | | |
| None | None | N/A | 5119 | 5622416 | 11.83 |
| 15% Ch108 | Trimethylammonium | 13-59-13 | 4361 | 5137461 | 15.87 |
| 15% Ch106 | Phosphatidylcholine | 9-37-9 | 230 | 392577 | 20.18 |
| Experiment 2 | | | | | |
| None | None | N/A | 7019 | 6572342 | 12.15 |
| 33% Ch112 | Phosphatidylethanolamine | 9-36-9 | 8118 | 4970692 | 11.25 |
| 66% Ch112 | Phosphatidylethanolamine | 9-36-9 | 1527 | 101074 | 11.88 |
| Experiment 3 | | | | | |
| None | None | N/A | 7292 | 6806670 | 12.30 |
| 20% Ch112 | Phosphatidylethanolamine | 9-36-9 | 5730 | 4265030 | 14.67 |
| 30% Ch112 | Phosphatidylethanolamine | 9-36-9 | 7390 | 4036358 | 11.49 |
| 40% Ch112 | Phosphatidylethanolamine | 9-36-9 | 7955 | 5020002 | 12.13 |
| Experiment 4 | | | | | |
| 33% Ch112 | Phosphatidylethanolamine | 9-36-9 | 6304 | 5181007 | 19.68 |
| 10% Ch114 | Phosphatidylethanolamine | 12-55-12 | 2484 | 2612650 | 18.91 |
| 40% Ch114 | Phosphatidylethanolamine | 12-55-12 | 7163 | 6136710 | 18.25 |
| Experiment 5 | | | | | |
| 15% Ch111 | Standard | 12-50-12 | 7752 | 4759209 | 18.35 |
| 5% Ch115 | Carboxylic acid | 9-39-9 | 2313 | 3081366 | 23.25 |
| 25% Ch115 | Carboxylic acid | 9-39-9 | 6791 | 7568571 | 24.77 |
| Experiment 6 | | | | | |
| 15% Ch111 | Standard | 12-50-12 | 6200 | 5664618 | 23.93 |
| 5% Ch116 | Carboxylic acid | 11-49-11 | 5490 | 6285791 | 22.49 |
| 25% Ch116 | Carboxylic acid | 11-49-11 | 4979 | 4260557 | 26.44 |
| Experiment 7 | | | | | |
| 33% Ch112 | Phosphatidylethanolamine | 9-36-9 | 6826 | 6142362 | 21.60 |
| 20% Ch113 | Phosphatidylethanolamine | 9-42-9 | 6494 | 4575920 | 18.91 |
| 33% Ch113 | Phosphatidylethanolamine | 9-42-9 | 5241 | 3315146 | 21.67 |
| 50% Ch113 | Phosphatidylethanolamine | 9-42-9 | 8132 | 4561245 | 19.81 |
| Experiment 8 | | | | | |
| 15% Ch117 | Standard | 9-39-9 | 6816 | 7078275 | 24.71 |
| 5% Ch120 | Sulfonate | 10-40-10 | 3958 | 2824698 | 14.69 |
| 15% Ch120 | Sulfonate | 10-40-10 | 3034 | 2654776 | 18.62 |
| 25% Ch120 | Sulfonate | 10-40-10 | 4136 | 2747584 | 21.50 |
| Experiment 9 | | | | | |
| 15% Ch117 | Standard | 9-39-9 | 5030 | 5593548 | 27.01 |
| 5% Ch119 | Sulfobetaine | 10-38-10 | 4052 | 3733436 | 19.23 |
| 15% Ch119 | Sulfobetaine | 10-38-10 | 3776 | 3800730 | 23.39 |
| 25% Ch119 | Sulfobetaine | 10-38-10 | 3784 | 4440915 | 47.76 |
| Experiment 10 | | | | | |
| 15% Ch121 | Standard | 12-44-12 | 5859 | 5474137 | 22.97 |
| 5% Ch124 | Sulfonate | 12-45-12 | 5162 | 6521245 | 20.00 |
| 15% Ch124 | Sulfonate | 12-45-12 | 6183 | 7943063 | 22.39 |
| 25% Ch124 | Sulfonate | 12-45-12 | 5878 | 6984980 | 21.51 |
| Experiment 11 | | | | | |
| 15% Ch121 | Standard | 12-44-12 | 7715 | 4790796 | 14.26 |
| 5% Ch123 | Sulfobetaine | 12-37-12 | 4290 | 2839704 | 10.90 |
| 15% Ch123 | Sulfobetaine | 12-37-12 | 4661 | 3630856 | 13.93 |
| 25% Ch123 | Sulfobetaine | 12-37-12 | 4311 | 2993126 | 15.15 |
| Experiment 12 | | | | | |
| 15% Ch117 | Standard | 9-39-9 | 5154 | 3569700 | 14.91 |
| 15% Ch115 | Carboxylic acid | 9-39-9 | 7306 | 4975546 | 14.42 |
| 15% Ch120 | Sulfonate | 10-40-10 | 3333 | 2358192 | 13.36 |
| 15% Ch124 | Sulfonate | 12-45-12 | 5807 | 4000244 | 12.02 |
| Experiment 13 | | | | | |
| 15% Ch118 | Triazole-alcohol | 9-37-9 | 7950 | 3705636 | 12.85 |
| 25% Ch118 | Triazole-alcohol | 9-37-9 | 6203 | 2582450 | 12.81 |
| 15% Ch122 | Triazole-alcohol | 12-41-12 | 8022 | 4415302 | 12.79 |
| 25% Ch122 | Triazole-alcohol | 12-41-12 | 7598 | 3903214 | 13.27 |
| Experiment 14 | | | | | |
| 15% Ch118 | Triazole-alcohol | 9-37-9 | 7102 | 3694296 | 18.24 |
| 5% Ch125 | Triazole-octylamine | 10-31-10 | 115 | 11937 | 4.94 |
| 15% Ch125 | Triazole-octylamine | 10-31-10 | 7332 | 4601751 | 19.97 |
| 25% Ch125 | Triazole-octylamine | 10-31-10 | 7509 | 4367710 | 18.26 |
| Experiment 15 | | | | | |
| 15% Ch118 | Triazole-alcohol | 9-37-9 | 7095 | 4627239 | 21.05 |
| 5% Ch127 | Triazole- | 9-30-9 | 4549 | 5146990 | 17.61 |
| | benzenedicarboxylate | | | | |
| 15% Ch127 | Triazole- | 9-30-9 | 5450 | 6015116 | 24.26 |
| | benzenedicarboxylate | | | | |
| 25% Ch127 | Triazole- | 9-30-9 | 6891 | 6284427 | 19.91 |
| | benzenedicarboxylate | | | | |
| Experiment 16 | | | | | |
| 15% Ch122 | Triazole-alcohol | 12-41-12 | 7194 | 4179461 | 14.70 |
| 5% Ch126 | Triazole-octylamine | 11-37-11 | 5719 | 4907115 | 15.79 |
| 15% Ch126 | Triazole-octylamine | 11-37-11 | 7166 | 5780612 | 16.42 |
| 25% Ch126 | Triazole-octylamine | 11-37-11 | 7798 | 6170682 | 17.05 |
| Experiment 17 | | | | | |
| 15% Ch122 | Triazole-alcohol | 12-41-12 | 7829 | 5137640 | 18.69 |
| 5% Ch128 | Triazole- | 12-24-12 | 5043 | 5462749 | 18.06 |
| | benzenedicarboxylate | | | | |
| 15% Ch128 | Triazole- | 12-24-12 | 6342 | 6606640 | 18.33 |
| | benzenedicarboxylate | | | | |
| 25% Ch128 | Triazole- | 12-24-12 | 6835 | 5882089 | 17.81 |
| | benzenedicarboxylate | | | | |
| Experiment 18 | | | | | |
| None | None | None | 4005 | 4119768 | 16.66 |
| 15% Ch129 | Triazole-phosphate | 13-31-13 | 6035 | 6036917 | 15.94 |
| 15% Ch130 | Triazole-phosphate | 12-40-12 | 5812 | 5881326 | 15.35 |
| 15% Ch131 | Triazole-dicarboxylate | 9-33-9 | 6774 | 6383883 | 14.49 |
| | (aliphatic) | | | | |
| Experiment 19 | | | | | |
| None | None | None | 5559 | 6764500 | 16.78 |
| 15% Ch132 | Triazole-dicarboxylate | 11-34-11 | 6266 | 6278492 | 15.87 |
| | (aliphatic) | | | | |
| 15% Ch133 | Triazole-dicarboxylate | 9-32-9 | 5508 | 5831342 | 16.98 |
| | (aliphatic) | | | | |
| 15% Ch134 | Triazole-dicarboxylate | 11-33-11 | 6692 | 6341714 | 14.59 |
| | (aliphatic) | | | | |
| Experiment 20 | | | | | |
| None | None | None | 1276 | 1239326 | 14.68 |
| 15% Ch135 | Triazole-amino acid | 9-39-9 | 3622 | 2857692 | 20.08 |
| | (zwitterion) | | | | |
| 15% Ch136 | Triazole-amino acid | 11-36-11 | 4823 | 4660802 | 15.35 |
| | (zwitterion) | | | | |

The results of the experiments in Table 4 confirm that various headgroup modifications are also able to modulate sequencing cell yield and molecules sequenced per minute per cell. Relative to unmodified lipid, modified headgroups as hybrid membranes for sequencing can give improvements in molecules sequenced per minute per cell (Table 4, Experiment 1) or can improve the number of cells performing sequencing while achieving similar sequenced molecules per minute per cell (Table 4, Experiment 2). With headgroup modified polymers, the tolerance in composition can be higher than for an unmodified polymer and headgroup properties can significantly impact yield and throughput. Comparison of Experiment 1 with Experiments 2-4 indicate the necessity of a phosphatidylethanolamine headgroup modification to achieve good cell yield relative to a phosphatidylcholine headgroup which displays significantly lower cell yield. Carboxylic acid or phosphate containing headgroups (Experiments 5, 6, 15, 17, 18, 19) can achieve higher throughput and similar cell yield to an unmodified or standard polymer. Triazole-alcohol and triazole-octylamine headgroups can be beneficial for cell yield but display reduced throughput relative to carboxylate headgroups. Sulfonate and sulfobetaine headgroups can display reduced cell yield relative to other polymers.

A third set of experiments was performed to understand the resulting properties of membranes containing more than 1 synthetic triblock copolymer added, as displayed in Table 5 below.

### Table 5

TABLE 5

| | | Avg | | | |
|---|---|---|---|---|---|
| | | polymer | Cell with | Number of | |
| | | size | Functional | Molecules | |
| | | (PMOXA- | Sequencing | Sequenced | Sequenced |
| | | PDMS- | (200x | (200x | Molecules/ |
| | Terminal Headgroup | PMOXA) | subsampled) | subsampled) | min/cell |
| Experiment 1 | | | | | |
| None | None | N/A | 3820 | 2907272 | 10.65 |
| 20% Ch115 | Carboxylic acid | 9-39-9 | 6570 | 4299615 | 14.86 |
| 10% Ch113 + | PE/Carboxylic acid | 9-42-9 + 9- | 7981 | 5492230 | 14.26 |
| 10% Ch115 | | 39-9 | | | |
| 10% Ch117 + | Standard/Carboxylic | 9-39-9 + 9- | 6042 | 4267633 | 14.87 |
| 10% Ch115 | acid | 39-9 | | | |
| Experiment 2 | | | | | |
| 20% Ch115 | Carboxylic acid | 9-39-9 | 6346 | 4539752 | 15.41 |
| 10% Ch120 + | Sulfonate/Carboxylic | 10-40-10 + | 2828 | 1756988 | 11.88 |
| 10% Ch115 | acid | 9-39-9 | | | |
| 10% Ch119 + | Sulfobetaine/Carboxylic | 10-38-10 + | 5371 | 4442600 | 16.43 |
| 10% Ch115 | acid | 9-39-9 | | | |
| 10% Ch116 + | Carboxylic acids | 11-49-11 + | 5880 | 4708536 | 16.00 |
| 10% Ch115 | | 9-39-9 | | | |
| Experiment 3 | | | | | |
| 20% Ch115 | Carboxylic acid | 9-39-9 | 8439 | 4522642 | 13.99 |
| 10% Ch113 + | PE/Carboxylic acid | 9-42-9 + | 7377 | 5030376 | 13.91 |
| 10% Ch115 | | 9-39-9 | | | |
| 10% Ch123 + | Sulfobetaine/Carboxylic | 12-37-12 + | 6398 | 4438769 | 16.90 |
| 10% Ch115 | acid | 9-39-9 | | | |
| 10% Ch124 + | Sulfonate/Carboxylic | 12-45-12 + | 6813 | 4695258 | 14.24 |
| 10% Ch115 | acid | 9-39-9 | | | |
| Experiment 4 | | | | | |
| 10% Ch113 + | PE/Carboxylic acid | 9-42-9 + 9- | 6878 | 5383018 | 22.99 |
| 10% Ch115 | | 39-9 | | | |
| 10% Ch114 + | PE/Carboxylic acid | 12-55-12 + | 7507 | 5411609 | 23.83 |
| 10% Ch116 | | 11-49-11 | | | |
| 10% Ch125 + | Amine/Dicarboxylic | 10-31-10 + | 6137 | 6011824 | 21.88 |
| 10% Ch127 | acid | 9-30-9 | | | |
| 10% Ch126 + | Amine/Dicarboxylic | 11-37-11 + | 6247 | 6628378 | 24.38 |
| 10% Ch128 | acid | 12-24-12 | | | |
| Experiment 5 | | | | | |
| 10% Ch126 + | Octylamine/triazole- | 11-37-11 + | 5272 | 4068985 | 14.75 |
| 10% Ch122 | alcohol | 12-41-12 | | | |
| 10% Ch126 + | Octylamine/triazole- | 11-37-11 + | 6610 | 4155320 | 13.40 |
| 10% Ch118 | alcohol | 9-37-9 | | | |
| 10% Ch126 + | Octylamine/no | 11-37-11 + | 7844 | 4048005 | 12.49 |
| 10% Ch117 | modification | 9-39-9 | | | |
| 10% Ch126 + | Octylamine/Benzenedicarboxylate | 11-37-11 + | 6442 | 4119851 | 13.77 |
| 10% Ch128 | | 12-24-12 | | | |

Table 5, Experiment 1 again displays the ability of these mixtures with DPhPE lipid and more than one additional triblock copolymer to have improved molecules sequenced per minute per cell relative to standard DPhPE with no added triblock copolymer. In this instance the more complex mixtures can afford considerable gains in number of cells performing sequencing as well. Polymer composition in the membrane can modulate cell yield and throughput for sequencing molecules in each cell as a result of mixing unmodified and headgroup modified polymers.

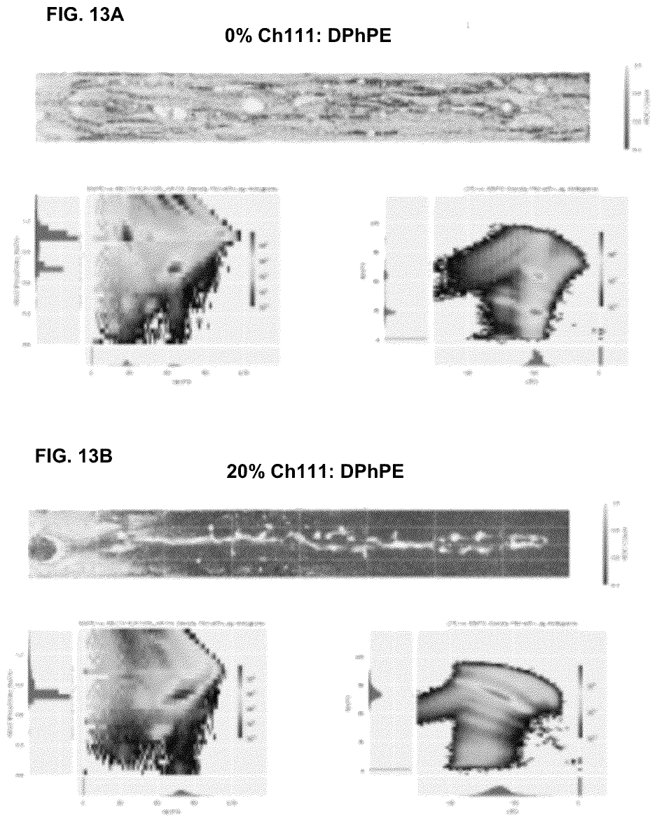

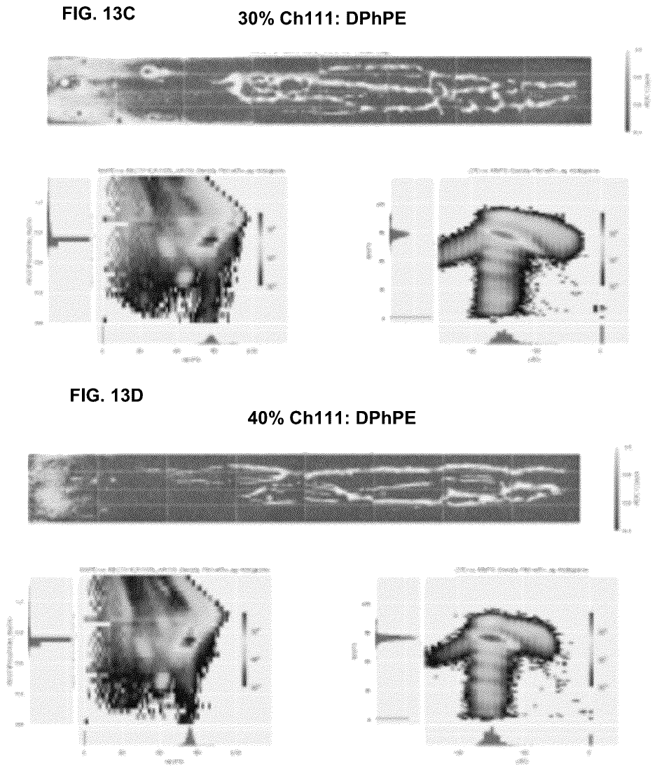

A further gain in all experiments utilizing synthetic triblock copolymers is the elimination of an undesired population of nanopore that are incapable of providing sequencing data. When performing a sequencing experiment with just DPhPE lipid, a considerable amount of non-sequencing pores is generated. As shown by the results depicted in the image of FIG. 13A, the use of a DPhPE only lipid bilayer gives a bimodal distribution in each left inset graph on the vertical axes, indicating that it has a considerable population of array cells with embedded nanopores that will be unable to perform a sequencing experiment. As shown by the results depicted in the images of FIG. 13B, FIG. 13C, and FIG. 13D, the addition of the 20%, 30%, or 40% TBC Ch111 relative to DPhPE in the lipid bilayer eliminates the nonfunctional population and affords a greater probability of successful sequencing data.

All publications, patents, patent applications and other documents cited in this application are hereby incorporated by reference in their entireties for all purposes to the same extent as if each individual publication, patent, patent application or other document were individually indicated to be incorporated by reference for all purposes.

While various specific embodiments have been illustrated and described, it will be appreciated that various changes can be made without departing from the spirit and scope of the invention(s).

### SPECIFICALLY INCLUDED EMBODIMENTS

The following embodiments are specifically contemplated as part of the disclosure. This is not intended to an exhaustive listing of potentially claimed embodiments within the scope of the disclosure.

Embodiment 1. A triblock copolymer compound of the formula: R1-(PMOXA)m-(PDMS)n-(PMOXA)m-R2 wherein R1 is an azide, or terminal head group comprising a triazole; PMOXA is a poly(2-methyl-2-oxazoline) subunit; PDMS is a poly(dimethylsiloxane) subunit; R2 is —OH, an azide, or a terminal head group comprising a triazole; and m is 4 to 20, and n is 20 to 60.

Embodiment 2. The compound of embodiment 1, wherein R1 is a terminal head group comprising a triazole and R2 is —OH, or R1 and R2 is a terminal head group comprising a triazole.

Embodiment 3. The compound of any one of embodiments 1-2, wherein the terminal head group comprising a triazole further comprises a group selected from: hydroxyl, alcohol, azide, ester, amine, amide, alkyl, heteroalkyl, aryl, heteroaryl, carboxylate, terephthalate, phosphate, phosphatidylethanolamine, sulfonate, and sulfobetaine.

Embodiment 4. The compound of any one of embodiments 1-3, wherein the terminal head group comprising a triazole is selected from:

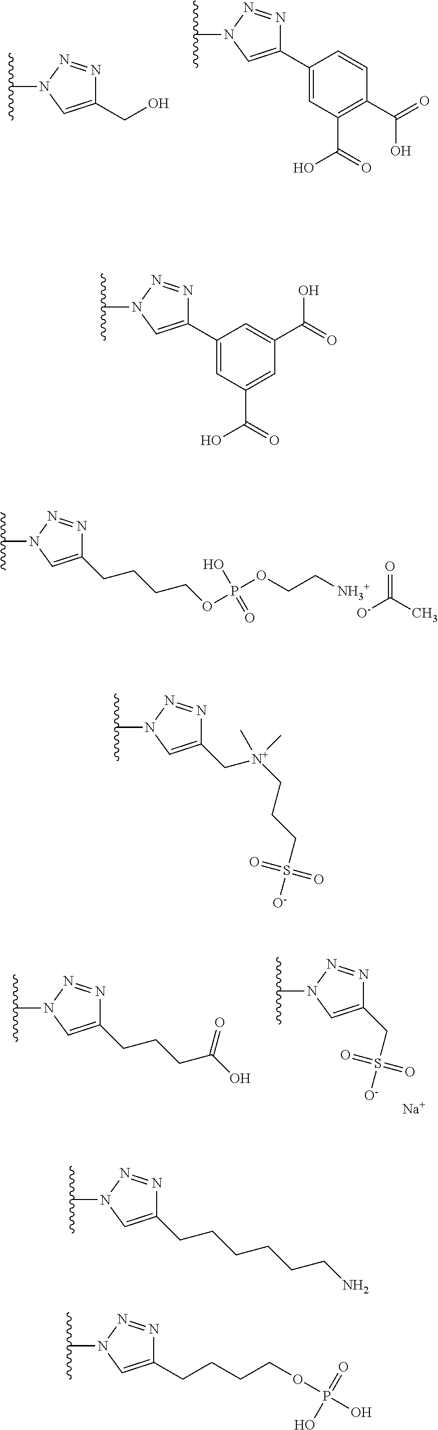

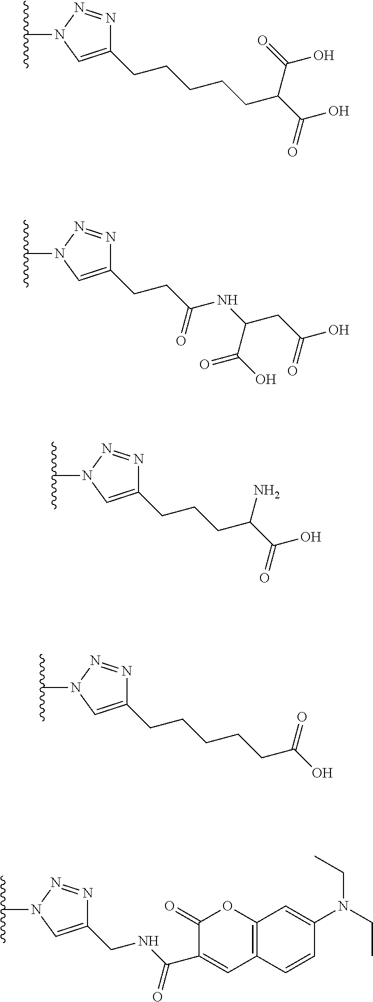 [SMILES: *n1cc(CCCCCC(C(=O)O)C(=O)O)nn1 ; *n1cc(CCC(=O)NC(CC(=O)O)C(=O)O)nn1 ; *n1cc(CCCC(N)C(=O)O)nn1 ; *n1cc(CCCCCC(=O)O)nn1 ; *n1cc(CNC(=O)c2cc3ccc(N(CC)CC)cc3oc2=O)nn1]

Embodiment 5. The compound of any one of embodiments 1-4, wherein the terminal head group comprising a triazole further comprises a fluorescent moiety; optionally, wherein the fluorescent moiety comprises a coumarin moiety or coumarin derivative moiety.

Embodiment 6. The compound of embodiment 1, wherein R1 is an azide and R2 is —OH, or R1 and R2 is an azide.

Embodiment 7. The composition of any one of embodiments 1-6, wherein the average values for m and n values are selected from:

$$m = 12 , n = 21 ; \qquad ( Ch03 )$$

$$m = 8 , n = 34 ; \qquad ( Ch05 )$$

$$m = 7 , n = 21 ; \qquad ( Ch15 )$$

$$m = 9 , n = 30 ; \qquad ( Ch20 / Ch127 )$$

$$m = 11 , n = 40 ; \qquad ( Ch42 )$$

$$m = 9 , n = 37 ; \qquad ( Ch67 )$$

$$m = 5 , n = 18 ; \qquad ( Ch71 )$$

$$m = 5 , n = 17 ; \qquad ( Ch72 )$$

$$m = 4 , n = 18 ; \qquad ( Ch74 )$$

$$m = 11 , n = 53 ; \qquad ( Ch93 )$$

$$m = 9 , n = 37 ; \qquad ( Ch103 )$$

$$m = 12 , n = 53 ; \qquad ( Ch104 )$$

$$m = 9 , n = 37 ; \qquad ( Ch106 / Ch118 )$$

$$m = 13 , n = 59 ; \qquad ( Ch108 )$$

$$m = 13 , n = 52 ; \qquad ( Ch109 )$$

$$m = 11 , n = 49 ; \qquad ( Ch110 )$$

$$m = 12 , n = 50 ; \qquad ( Ch111 )$$

$$m = 9 , n = 36 ; \qquad ( Ch112 )$$

$$m = 9 , n = 42 ; \qquad ( Ch113 )$$

$$m = 12 , n = 55 ; \qquad ( Ch114 )$$

$$m = 9 , n = 39 ; \qquad ( Ch115 / Ch117 )$$

$$m = 11 , n = 49 ; \qquad ( Ch116 )$$

$$m = 10 , n = 38 ; \qquad ( Ch119 )$$

$$m = 10 , n = 40 ; \qquad ( Ch120 )$$

$$m = 12 , n = 44 ; \qquad ( Ch121 )$$

$$m = 12 , n = 41 \qquad ( Ch122 )$$

$$m = 12 , n = 37 \qquad ( Ch123 )$$

$$m = 12 , n = 45 \qquad ( Ch124 )$$

$$m = 10 , n = 31 \qquad ( Ch125 )$$

$$m = 11 , n = 37 \qquad ( Ch126 )$$

$$m = 12 , n = 24 \qquad ( Ch128 )$$

$$m = 13 , n = 31 \qquad ( Ch129 )$$

$$m = 12 , n = 40 \qquad ( Ch130 )$$

$$m = 9 , n = 33 \qquad ( Ch131 )$$

$$m = 11 , n = 34 \qquad ( Ch132 )$$

$$m = 9 , n = 32 \qquad ( Ch133 )$$

$$m = 11 , n = 33 \qquad ( Ch134 )$$

$$m = 9 , n = 39 \qquad ( Ch135 )$$

$$m = 11 , n = 36 \qquad ( Ch136 )$$

and a mixture thereof.

Embodiment 8. A method for synthesizing a triblock copolymer compound of formula R1-(PMOXA)m-(PDMS)n-(PMOXA)m-R2 wherein R1 is an azide; R2 is —OH, an azide; PMOXA is a poly(2-methyl-2-oxazoline) subunit; PDMS is a poly(dimethylsiloxane) subunit; and m is 4 to 20, and n is 20 to 60; the method comprising: (a) providing a compound of formula RA (PMOXA)m-(PDMS)n-(PMOXA)m-RB wherein RA and RB are 2-methyl-2-oxazolinium triflate groups; (b) dissolving compound of (a) in acetonitrile and mixing with sodium azide at a ratio of 1 equivalent of compound of (a) to 70 equivalents of sodium azide for 45 h at 80° C. under inert atmosphere; and (c) cooling to RT, filtering off unreacted sodium azide, and evaporating solvent.

Embodiment 9. A method for synthesizing a triblock copolymer compound of any one of embodiments 1-7, the method comprising: (a) mixing in ethanol 2.5-3.5 equivalents of a compound of formula R1-alkyne, and/or R2-alkyne with 1 equivalent of a compound of formula RA-(PMOXA)m-(PDMS)n-(PMOXA)m-RB wherein RA is an azide; RB is —OH, an azide; PMOXA is a poly(2-methyl-2-oxazoline) subunit; PDMS is a poly(dimethylsiloxane) subunit; and m is 4 to 20, and n is 20 to 60; (b) purging the mixture with inert gas; and (c) adding a catalytic amount of copper nanoparticles and stirring for 2-3 h at 60° C. under inert atmosphere.

Embodiment 10. A membrane composition comprising a TBC compound of any one of embodiments 1-7.

Embodiment 11. A polymersome composition comprising a TBC compound of any one of embodiments 1-7.

1. A triblock copolymer compound of formula: 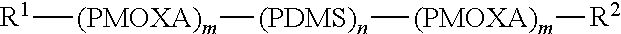
wherein
R¹ is an azide, or terminal head group comprising a triazole;
PMOXA is a poly(2-methyl-2-oxazoline) subunit;
PDMS is a poly(dimethylsiloxane) subunit;
R² is —OH, an azide, or a terminal head group comprising a triazole; and
m is 4 to 20, and n is 20 to 60.

2. The compound of claim 1, wherein R¹ is a terminal head group comprising a triazole and R² is-OH, or R¹ and R² is a terminal head group comprising a triazole.

3. The compound of claim 1, wherein the terminal head group comprising a triazole further comprises a group selected from: hydroxyl, alcohol, azide, ester, amine, amide, alkyl, heteroalkyl, aryl, heteroaryl, carboxylate, terephthalate, phosphate, phosphatidylethanolamine, sulfonate, and sulfobetaine.

4. The compound of claim 1, wherein the terminal head group comprising a triazole is selected from:

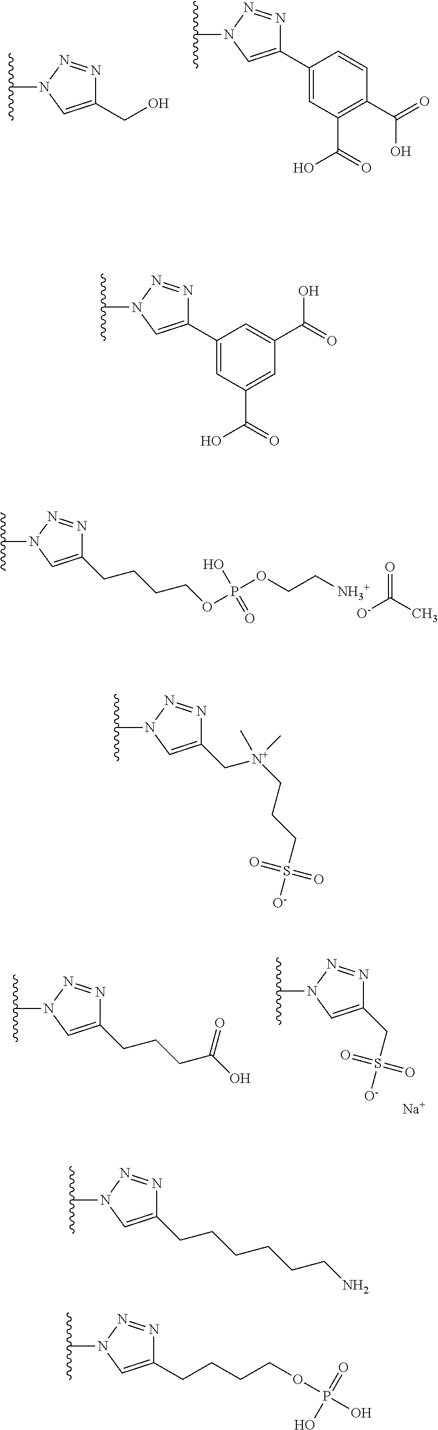

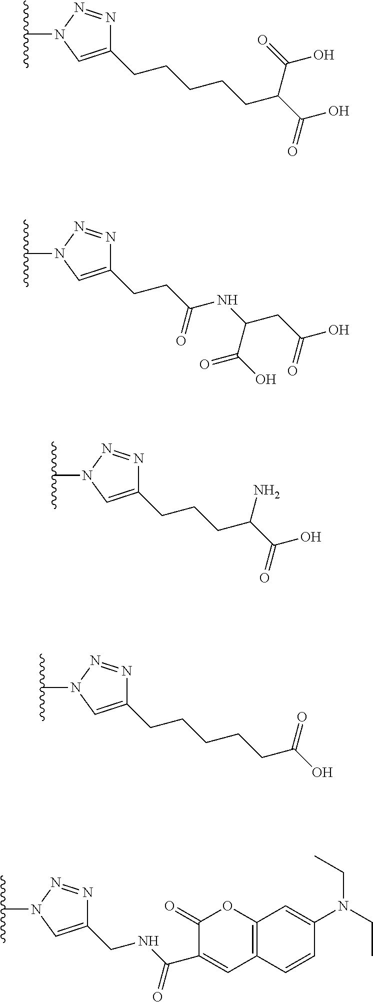 [SMILES: *n1cc(CCCCCC(C(=O)O)C(=O)O)nn1 ; *n1cc(CCC(=O)NC(CC(=O)O)C(=O)O)nn1 ; *n1cc(CCCC(N)C(=O)O)nn1 ; *n1cc(CCCCCC(=O)O)nn1 ; *n1cc(CNC(=O)c2cc3ccc(N(CC)CC)cc3oc2=O)nn1]

5. The compound of claim 1, wherein the terminal head group comprising a triazole further comprises a fluorescent moiety; optionally, wherein the fluorescent moiety comprises a coumarin moiety or coumarin derivative moiety.

6. The compound of claim 1, wherein R¹ is an azide and R² is —OH, or R¹ and R² is an azide.

7. The composition of claim 1, wherein the average values for m and n values are selected from:
$$m = 12 , n = 21 ; \qquad ( Ch03 )$$
$$m = 8 , n = 34 ; \qquad ( Ch05 )$$
$$m = 7 , n = 21 ; \qquad ( Ch15 )$$
$$m = 9 , n = 30 ; \qquad ( Ch20 / Ch127 )$$
$$m = 11 , n = 40 ; \qquad ( Ch42 )$$
$$m = 9 , n = 37 ; \qquad ( Ch67 )$$
$$m = 5 , n = 18 ; \qquad ( Ch71 )$$
$$m = 5 , n = 17 ; \qquad ( Ch72 )$$
$$m = 4 , n = 18 ; \qquad ( Ch74 )$$
$$m = 11 , n = 53 ; \qquad ( Ch93 )$$
$$m = 9 , n = 37 ; \qquad ( Ch103 )$$
$$m = 12 , n = 53 ; \qquad ( Ch104 )$$
$$m = 9 , n = 37 ; \qquad ( Ch106 / Ch118 )$$
$$m = 13 , n = 59 ; \qquad ( Ch108 )$$
$$m = 13 , n = 52 ; \qquad ( Ch109 )$$
$$m = 11 , n = 49 ; \qquad ( Ch110 )$$
$$m = 12 , n = 50 ; \qquad ( Ch111 )$$
$$m = 9 , n = 36 ; \qquad ( Ch112 )$$
$$m = 9 , n = 42 ; \qquad ( Ch113 )$$
$$m = 12 , n = 55 ; \qquad ( Ch114 )$$
$$m = 9 , n = 39 ; \qquad ( Ch115 / Ch117 )$$
$$m = 11 , n = 49 ; \qquad ( Ch116 )$$
$$m = 10 , n = 38 ; \qquad ( Ch119 )$$
$$m = 10 , n = 40 ; \qquad ( Ch120 )$$
$$m = 12 , n = 44 ; \qquad ( Ch121 )$$
$$m = 12 , n = 41 ; \qquad ( Ch122 )$$
$$m = 12 , n = 37 ; \qquad ( Ch123 )$$
$$m = 12 , n = 45 ; \qquad ( Ch124 )$$
$$m = 10 , n = 31 ; \qquad ( Ch125 )$$
$$m = 11 , n = 37 ; \qquad ( Ch126 )$$
$$m = 12 , n = 24 ; \qquad ( Ch128 )$$
$$m = 13 , n = 31 ; \qquad ( Ch129 )$$
$$m = 12 , n = 40 ; \qquad ( Ch130 )$$
$$m = 9 , n = 33 ; \qquad ( Ch131 )$$
$$m = 11 , n = 34 ; \qquad ( Ch132 )$$
$$m = 9 , n = 32 ; \qquad ( Ch133 )$$
$$m = 11 , n = 33 ; \qquad ( Ch134 )$$
$$m = 9 , n = 39 ; \qquad ( Ch135 )$$
$$m = 11 , n = 36 ; \qquad ( Ch136 )$$
and a mixture thereof.

8. A method for synthesizing a triblock copolymer compound of formula 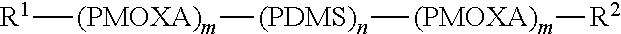
R¹ is an azide;
R² is —OH, an azide;
PMOXA is a poly(2-methyl-2-oxazoline) subunit;
PDMS is a poly(dimethylsiloxane) subunit; and
m is 4 to 20, and n is 20 to 60;
the method comprising:
(a) providing a compound of formula 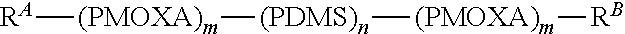
wherein
^{A} and R^{B} are 2-methyl-2-oxazolinium triflate groups;
(b) dissolving compound of (a) in acetonitrile and mixing with sodium azide at a ratio of 1 equivalent of compound of (a) to 70 equivalents of sodium azide for 45 h at 80° C. under inert atmosphere; and
(c) cooling to RT, filtering off unreacted sodium azide, and evaporating solvent.

9. A method for synthesizing the triblock copolymer compound claim 1, the method comprising:
(a) mixing in ethanol 2.5-3.5 equivalents of a compound of formula R¹-alkyne, and/or R²-alkyne with 1 equivalent of a compound of formula 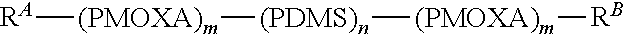
wherein
R^{A} is an azide;
R^{B} is —OH, an azide;
PMOXA is a poly(2-methyl-2-oxazoline) subunit;
PDMS is a poly(dimethylsiloxane) subunit; and
m is 4 to 20, and n is 20 to 60;
(b) purging the mixture with inert gas; and
(c) adding a catalytic amount of copper nanoparticles and stirring for 2-3 h at 60° C. under inert atmosphere.
